(19) United States
(12) Patent Application Publication
(10) Pub. No.: US 2015/0092877 A1
(43) Pub. Date: Apr. 2, 2015

(54) HIGH THROUGHPUT INTERFERENCE CANCELLING RADIO TRANSCEIVER AND ANTENNA THEREFOR

(71) Applicant: Terabit Radios, Inc., Milpitas, CA (US)

(72) Inventor: Srinivas Sivaprakasam, Fremont, CA (US)

(73) Assignee: Terabit Radios, Inc., Milpitas, CA (US)

(21) Appl. No.: 14/505,017

(22) Filed: Oct. 2, 2014

Related U.S. Application Data
(60) Provisional application No. 61/885,586, filed on Oct. 2, 2013.

(51) Int. Cl. H04W 24/02; H04L 5/14; H04B 7/06

(52) U.S. Cl. CPC H04W 24/02; H04B 7/0615; H04L 5/14
USPC 375/267

(57) ABSTRACT

A system for wireless transmission of signals is provided. A first radio unit is configured to communicate desired communication signals with a second radio unit. The first radio unit has a plurality of antennas configured to simultaneously receive a plurality of desired communication signals within a frequency channel. The first radio unit is configured to correlate signals received among its antennas to obtain one or more correlation coefficients, and using the correlation coefficients, the first radio unit is configured to multiply a received signal experiencing interference within the channel by an obtained correlation coefficient in order to remove interfering signals from the desired signals.

This application claims the benefit of U.S. Provisional Application No. 61/885,586, filed Oct. 2, 2013, the entire contents of which are hereby incorporated by reference.

### BACKGROUND OF THE INVENTION

The present invention relates to the field of radio communication systems and, more particularly, the present invention relates to high throughput radio transceivers and antennas.

With the advent of FM radio and television stations, wireless networks began as one-way broadcast systems. Cellular networks changed that to two-way communications but still the throughput requirements were low by today's standards. The coming of the Internet age, however, made high throughput (i.e. broadband) communications a necessity. Wireless communications have a big future in this area which also represents a convergence of cellular and broadband systems.

The demand for high throughput communications systems is ever-increasing in order to accommodate myriad uses including cloud computing, remote data storage and backup, business and banking data transfers, enterprise and educational campus networking, high-definition video streaming, and an increasing prevalence of mobile devices and applications.

Communication latency is also a significant consideration for communications systems. Minimizing communication latency is important in connections among financial institutions, including the major stock exchanges in the U.S. and abroad. For example, many transactions in the equity markets depend upon the speed in which a transaction or trade order is communicated and executed. In these contexts, reductions in communication latency can result in increases in profitability. Minimizing communication latency is also important for cellular and other voice communications, particularly long-distance voice communications, and is increasingly important for industries that rely upon cloud computing, including financial, medical, educational, government, video delivery, and so forth.

Communication interference is an additional consideration for communications systems. As an increasing number of communications systems become more densely packed into urban areas in response to demand for such systems, the likelihood of inference among them increases. Costs incurred due to network outages caused by interference can be significant, resulting from losses in productivity, missed deadlines, and so forth.

Wireless medium is inherently shared and presents unique interference challenges. This is particularly true for backhaul (PTP) applications, such as used by cellular operators, though interference occurs in many contexts. Because frequency spectrum is a finite and scarce resource, spectral efficiency also plays an important role. This is especially true for those using unlicensed bands. Because there is no protection afforded to such operations, they are subject to any amount of interference from nearby systems. In these situations, interference mitigation or cancellation techniques are increasingly important.

Interference issues have been conventionally handled through the use of other channels in the unlicensed bands. Also, transmission protocols such as those using spread spectrum techniques are designed to operate in somewhat interfered environments. However, the number of 40 MHz channels in 2.4 GHz unlicensed band for example are two and, in busy or crowded locations such as apartment complexes, one quickly runs out of channels to choose from. As for techniques such as spread spectrum, they can only handle a small amount of interference.

Accordingly there is a need for communication systems that provide high throughput and low latency and that are resistant to interference.

### SUMMARY OF THE INVENTION

A system for wireless transmission of signals is provided. A first radio unit is configured to communicate desired communication signals with a second radio unit. The first radio unit has a plurality of antennas configured to simultaneously receive a plurality of desired communication signals within a frequency channel. The first radio unit is configured to correlate signals received among its antennas to obtain one or more correlation coefficients, and using the correlation coefficients, the first radio unit is configured to multiply a received signal experiencing interference within the channel by an obtained correlation coefficient in order to remove interfering signals from the desired signals.

These and other advantages of the present invention will be apparent to those of ordinary skill in the art after having read the following detailed description of the preferred embodiments which are illustrated in the drawings and figures.

### BRIEF DESCRIPTION OF THE DRAWINGS

The present invention is described with respect to particular exemplary embodiments thereof and reference is accordingly made to the drawings in which:

FIG. 1 illustrates a wireless network comprising transmitting and receiving nodes in accordance with an embodiment of the present invention;

FIG. 2 illustrates a network having two-way, point-to-point communication links in accordance with an embodiment of the present invention;

FIG. 3 illustrates a two-way, point-to-point communication link in the presence of an undesirable interfering signal in accordance with an embodiment of the present invention;

FIG. 4 illustrates a point-to-multipoint radio transceiver in accordance with an embodiment of the present invention;

FIG. 5 illustrates a mesh network in accordance with an embodiment of the present invention;

FIG. 6 illustrates hardware board level components that make up a typical transmitter or receiver in accordance with an embodiment of the present invention;

FIG. 7 illustrates signal flow within a radio transceiver in accordance with an embodiment of the present invention;

FIG. 8 illustrates a block schematic diagram of a radio transmitter in accordance with an embodiment of the present invention;

FIG. 9 illustrates a block schematic diagram of a transmit digital signal processor in accordance with an embodiment of the present invention;

FIG. 10 illustrates a block schematic diagram of a radio receiver in accordance with an embodiment of the present invention;

FIG. 11 illustrates a signal processing block schematic diagram of a typical transmitter and receiver using OFDM techniques in accordance with an embodiment of the present invention;

FIGS. 12A-B illustrate typical modulation symbol constellations in accordance with an embodiment of the present invention;

FIG. 13 illustrates a trellis coded modulation (TCM) technique in accordance with an embodiment of the present invention;

FIG. 14 illustrates a block schematic diagram of a convolutional encoder that can be employed in a digital signal processor in accordance with an embodiment of the present invention;

FIG. 15 illustrates an adaptive equalizer used to remove channel distortions at a receiver in accordance with an embodiment of the present invention;

FIG. 16 illustrates a matrix representation of a plurality of interfering signals in accordance with an embodiment of the present invention;

FIG. 17 illustrates a typical link budget analysis of a system in the 2.4 GHz band in accordance with an embodiment of the present invention;

FIG. 18 illustrates a typical interference detection antenna arrangement in accordance with an embodiment of the present invention;

FIG. 19 illustrates antenna stack layers in accordance with an embodiment of the present invention;

FIG. 20 illustrates an antenna printed circuit board patch array and feed networks in accordance with an embodiment of the present invention;

FIG. 21 illustrates calculated antenna interference separation performance in accordance with an embodiment of the present invention;

FIG. 22 illustrates measured antenna isolation performance in accordance with an embodiment of the present invention;

FIG. 23 illustrates measured antenna cross-polarization isolation performance in accordance with an embodiment of the present invention;

FIG. 24 illustrates calculated antenna-to-antenna separation performance in accordance with an embodiment of the present invention; and

FIG. 25 illustrates a dual antenna array full duplex radio unit in accordance with an embodiment of the present invention.

### DETAILED DESCRIPTION OF A PREFERRED EMBODIMENT OF THE INVENTION

The present invention generally is in the area of wireless broadband communications. In accordance with embodiments of the present invention, methods and systems are provided for cancelling interference in wireless broadband communication networks using multiple input and multiple output (MIMO) antennas that are optimally arranged. A network of such antennas along with the associated electronics can result in dramatic increases in capacity over conventional techniques. This allows a network to operate normally despite other networks existing in the same frequency spectrum region at the same time. It also allows these communication links to be secure such that only the intended receiver can decode the wireless signal while all other receivers at nearby locations cannot decode due to excessive interference and lack of information to pull the desired signal out of interference.

The present invention provides a method for simultaneously cancelling one to many interferers in a given frequency channel. There is no a priori knowledge of the undesirable interference signal characteristics. All needed properties of the signal are estimated in real time using the signals themselves.

In accordance with embodiments of the present invention, methods and systems for secure and high capacity broadband wireless transmission in interference prone environments are provided. Significant improvements in capacity are provided while also providing security of communications. An embodiment of the present invention also results in interference cancellation in the presence of strong co-channel interferers such as due to neighboring wireless backhaul links on the same channel. Embodiments of the present invention provide increases in network capacity as measured at radio equipment. In a mesh network configuration, embodiments of the present invention provide increases in data rate seen by any single mesh node or device. Embodiments of the present invention can also inhibit devices from decoding a signal at locations other than the location of a desired receiving station. Using polarization and direction sensing of interfering networks, embodiments of the present invention also allow networks and backhaul links to operate in fully co-channel interfered locations.

Embodiments of the present invention provide systems and methods for broadband wireless communication using multiple antennas at the radio equipment. In accordance with an embodiment, a base station, point-to-point (PTP) node or access point uses multiple sectorized antennas to transmit or receive multiple data streams, fully synchronized in time and frequency, on the same channel.

In accordance with embodiments of the present invention, signal processing and interference handling techniques can be used to cancel interference present in the same channel from other nearby networks or backhaul link devices. Each such device can have at least two antennas and can identify the interfering signal from the desired signal. In addition to facing different directions, the antennas can also be of orthogonal polarizations so that polarization of an interfering signal can be identified and the desired signal can be adaptively made orthogonal to it. In this case, radio units communicating the desired signal can agree through a control channel to use a polarization that is orthogonal to that of the interfering signal.

In point-to-multipoint (PTMP) embodiments, channel estimation algorithms can play a useful role. By nature of the scattering environment, the broadband channel characteristics are frequency dependent and also time dependent. However, both single carrier and orthogonal frequency division multiplexing (OFDM) techniques can be used in these embodiments to make such channel identification easier. Embodiments of the present invention are described in connection with a proprietary system. However, embodiments of the present invention can be utilized on top of, or in connection with, existing standards such as WiFi or WiMax. For PTP backhaul interference cancellation applications, single carrier systems can also be employed in which the antennas are housed in a single unit and have a constant or stationary channel between them.

A number of antennas positioned at a backhaul unit can transmit or receive wireless signals on the same channel at the same time and frequency as a nearby unknown interferer. In this embodiment, a wireless network can be operated in the presence of very strong interfering networks. Even if the interference is much stronger than the desired signal, a wireless network employing this embodiment of the present invention can keep functioning.

A PTP backhaul interference cancelling link, and for a PTMP multi sector system, is described herein and exemplified in the accompanying illustrations. It should be understood however that description herein is by no means intended to limit the scope of the invention which a person of ordinary skill can use in other embodiments. On the contrary, alternatives, modifications and equivalent embodiments, are within the spirit and scope of the invention as defined by the attached claims. In the following description of the embodiments of the present invention, specific details are given so as to provide a thorough understanding of the invention. It will be apparent that the present invention can be reduced to practice without some or all of these specific details or descriptions.

In accordance with an embodiment of the present invention, a system for wireless transmission of signals is provided. A first radio unit is configured to communicate desired communication signals with a second radio unit, the first radio unit having a plurality of antennas configured to simultaneously receive a plurality of desired communication signals within a frequency channel. The first radio unit is configured to correlate signals received among its antennas to obtain one or more correlation coefficients, and using the correlation coefficients, the first radio unit is configured to multiply a received signal experiencing interference within the channel by an obtained correlation coefficient in order to remove interfering signals from the desired signals.

The plurality of antennas of the first radio unit can comprise sum and difference antenna ports, each providing a corresponding in-phase sum and out-of-phase difference signal, the sum and difference signals being among the signals received by the antennas and used to obtain the one or more correlation coefficients. The plurality of antennas of the first radio unit can further comprise horizontal and vertical polarized antennas, each providing a corresponding horizontal and vertical polarized signal, the horizontal and vertical polarized signals being among the signals received by the antennas and used to obtain the one or more correlation coefficients. The plurality of antennas of the first radio unit can further comprise left and right side antennas, each providing a corresponding left and right signal, the left and right signals being among the signals received by the antennas and used to obtain the one or more correlation coefficients.

The first radio unit can be configured to correlate signals received among its antennas to obtain a matrix of correlation coefficients and to multiply received signals experiencing interference by an inverse of the matrix of correlation coefficient in order to remove the interfering signals from the desired signals.

The first radio unit and a third radio unit having multiple antennas can be located in close proximity to each other and connected to the same baseband digital processor such that the first and third radio units operate in the same frequency channel in a full duplex manner and wherein the interfering signals from are cancelled by the common digital processor.

The antennas of the first radio unit can be included in an antenna patch array that provides as output the in-phase sum signal and the out-of-phase difference signal, and wherein when the antenna patch array is pointed toward the second radio unit, the antenna patch array receives almost no desired communication signal on the difference antenna port thereby ensuring that an antenna matrix is invertible.

The antennas of the first radio unit can have at least a pair of orthogonal polarizations and wherein polarization of at least one interfering signal is identified and the desired signal is adaptively made orthogonal to it. The radio units of the pair can agree through a control channel to use the polarization that is orthogonal to the interfering signal. The pair of orthogonal polarizations and sum and difference signals at the first radio unit can be used simultaneously to enhance communication security by providing that a desired signal is decodable only by the first radio unit of the pair due to a nulling resulting from use of the orthogonal polarizations and the sum and difference signals.

A null of at least one antenna of the first radio unit can be steered in the direction of at least one interfering node and a null of another antenna of the first radio unit is steered in the direction of the desired signal so that the two antenna signals have a maximum separation.

The desired communication signals can be in accordance with a wireless communication standard, such as IEEE 802.11. The correlation coefficients can be obtained by analyzing received data packets that are scheduled to arrive sequentially and quasi periodically.

The first radio unit can be configured to communicate in accordance with OFDMA techniques and wherein a channel estimation and control channel is used to identify an optimal modulation technique usable for each of a plurality of sub carriers, the modulation technique being selected depending on fading and interference detected on each said sub carrier.

The first radio unit can be configured to communicate in accordance with OFDMA techniques and wherein a channel estimation and control channel is used to optimally allocate each of a plurality of sub carriers to a particular node in each sector.

Multiple antenna beamforming techniques can be used in each of a plurality of sectors for interference cancellation. Multiple antenna beamforming techniques can be used in each of a plurality of sectors for increasing communication range. Increasing of the communication range can be obtained through power level increase due to beamforming and traded off with interference cancellation efficiency.

One or more interfering nodes in proximity of one or both of the first and second radio units can simultaneously transmit one or more interfering signals in the same frequency channel used by the radio units.

In accordance with an embodiment of the present invention, a system for wireless transmission of signals is provided. A first radio unit is configured to communicate desired communication signals with a second radio unit. The first radio unit has a plurality of antennas configured to simultaneously receive a plurality of desired communication signals within a frequency channel. The antennas of the first radio unit are included in an antenna patch array that provides as output an in-phase sum signal and the out-of-phase difference signal, and wherein the plurality of antennas of the first radio unit further comprise horizontal and vertical polarized antennas, each providing a corresponding horizontal and vertical polarized signal, and wherein the plurality of antennas of the first radio unit further comprise left and right side antennas, each providing a corresponding left and right signal.

The first radio unit can be configured to correlate signals received among its antennas to obtain one or more correlation coefficients, and using the correlation coefficients, the first radio unit is configured to multiply a received signal experiencing interference within the channel by an obtained correlation coefficient in order to remove interfering signals from the desired signals.

The antenna patch array can comprise a plurality of planar antenna patches arranged on a substrate that measures approximately 5.5 inches by 5.5 inches. The plurality of planar antenna patches can each be approximately 3.5 centimeters by 3.5 centimeters. The plurality of planar antenna patches can be spaced apart by approximately one centimeter or less. The plurality of planar antenna patches can consist of 32 patches. The antenna patch array can include a plurality of planar antenna patches, wherein each patch has dual polarizations and wherein the patches are arranged is left and right groups and wherein a feed network coupled to the left and right groups provides as output the in-phase sum signal and the out-of-phase difference signal. The dual polarizations, left and right groups, and the in sum difference signals can effectively provide eight different antenna signals.

Exemplary Transmitting, Receiving Unit and Applications

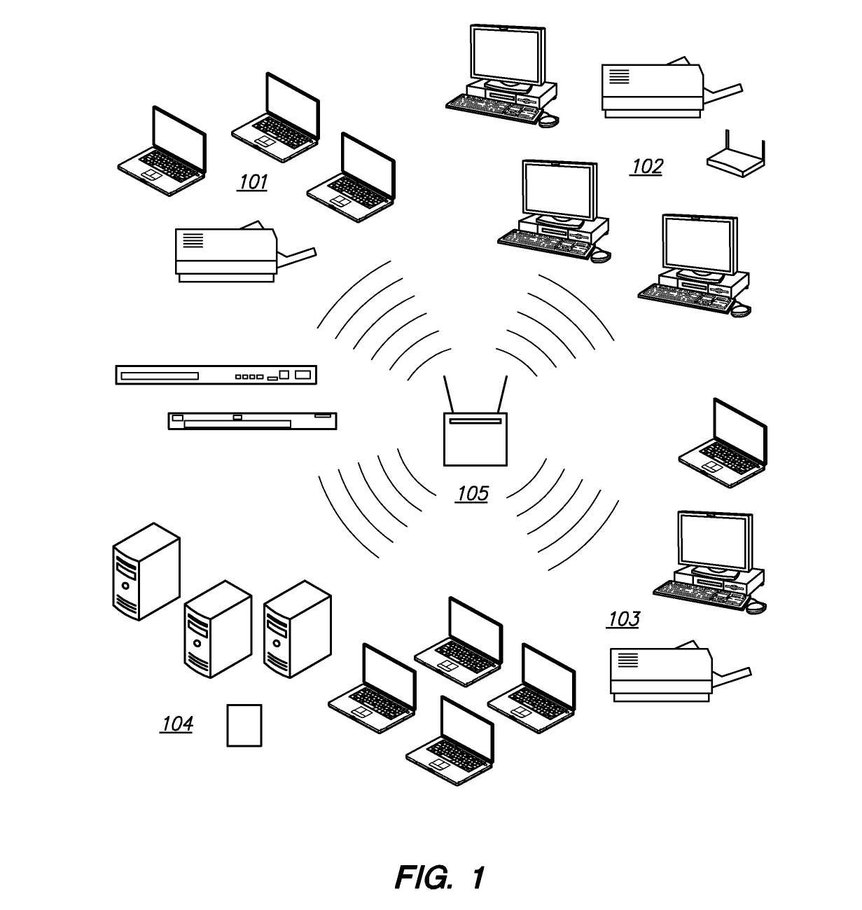

FIG. 1 illustrates a wireless network comprising transmitting and receiving nodes in accordance with an embodiment of the present invention. In a typical embodiment, a transmitting and receiving node can be connected and be a member of a network of devices which can include laptop computers 101, desktop computers 102, 103, servers 104, access points 105, printers, handheld devices such as cell phones or smart phones, base stations, routers, and so forth. Some of these devices can be connected to a Local Area Network (LAN) or any other form of wired or wireless network using a variety of interfaces and protocols such as Ethernet, USB, etc. Aspects of the present invention can be embodied in a variety of other devices and networks and configurations as well.

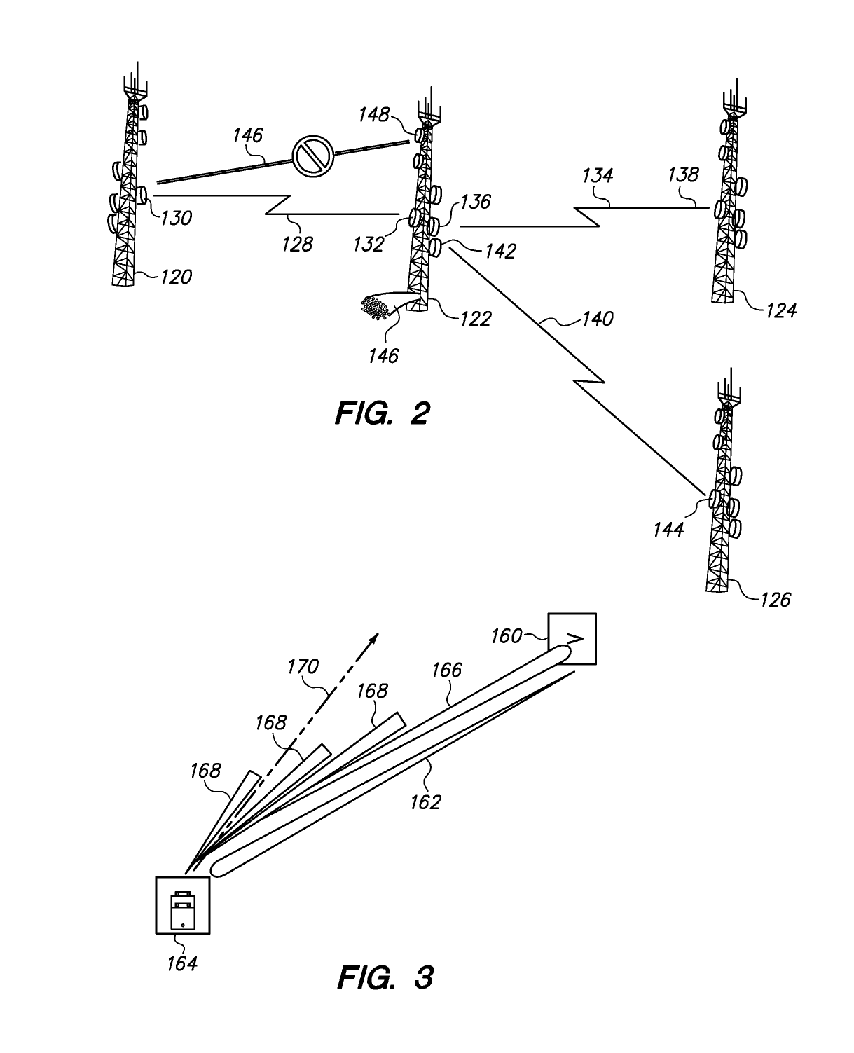

FIG. 2 illustrates a network having two-way, point-to-point communication links in accordance with an embodiment of the present invention. As shown in FIG. 2, a number of antenna towers 120, 122, 124, 126 are each fitted with one or more directional antennas. Two-way, point-to-point communication links can be established between pairs of antennas. As shown in FIG. 2, a communication link 128 is between antennas 130 and 132. Another communication link 134 is between antennas 136 and 138. Yet another communication link 140 is between antennas 142 and 144. FIG. 2 also shows that interference 146 transmitted by antenna 148 can be mitigated at receiving antenna 130. Also shown in FIG. 2 is an exemplary fiber link 150 which can serve as a point of presence by connect devices located on the tower 122 to another network, such as the Internet. Radios can be configured as end nodes or repeaters.

FIG. 3 illustrates a two-way, point-to-point communication link in the presence of an undesirable interfering signal in accordance with an embodiment of the present invention. As shown in FIG. 3, a transceiver station 160 transmits a main beam 162 to a transceiver station 164. The transceiver station 164 transmits a main beam to station 160. In addition, the transceiver station 164 transmits side lobes 168 and an undesirable interferer 170. In accordance with embodiments of the present invention, up to two interferers, up to −20 bD stronger than a desired signal can be rejected by either station 160, 164. When orthogonal frequency division multiplexing (OFDM) is employed, residual interference from a source directly in-line with the transmitter can be rejected. Adaptive coding and modulation can also be employed to mitigate effects of interference. Interference removal involves estimating the interference portion of a received signal and subtracting the estimated interference from the received signal in order to obtain an estimate of the desired transmitted signal.

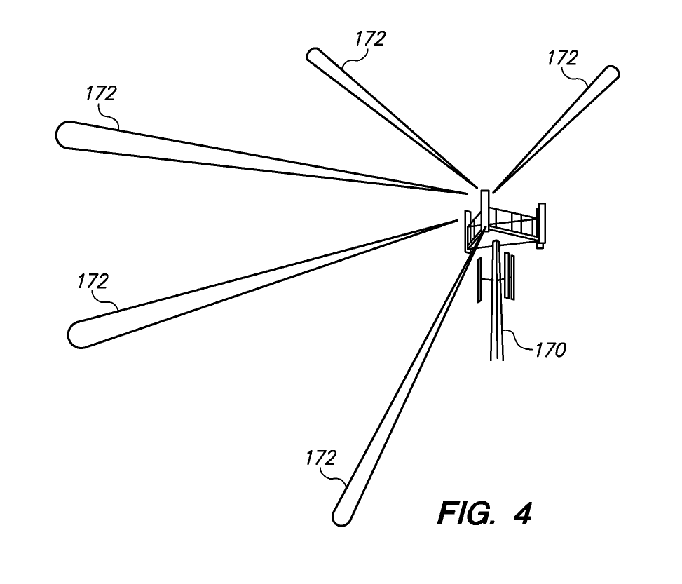

FIG. 4 illustrates a point-to-multipoint radio transceiver tower 170 in accordance with an embodiment of the present invention. As shown in FIG. 4, a plurality of beams 172 may be simultaneously transmitted the same frequency channel. Such a system can employ MIMO techniques to obtain high reuse of the channel spectrum. The beams 172 can, for example, have a data rate of up to 1 Gbps per beam. Up to 100 or more beams 172 can be employed resulting in total throughput of 100 Gbps or more.

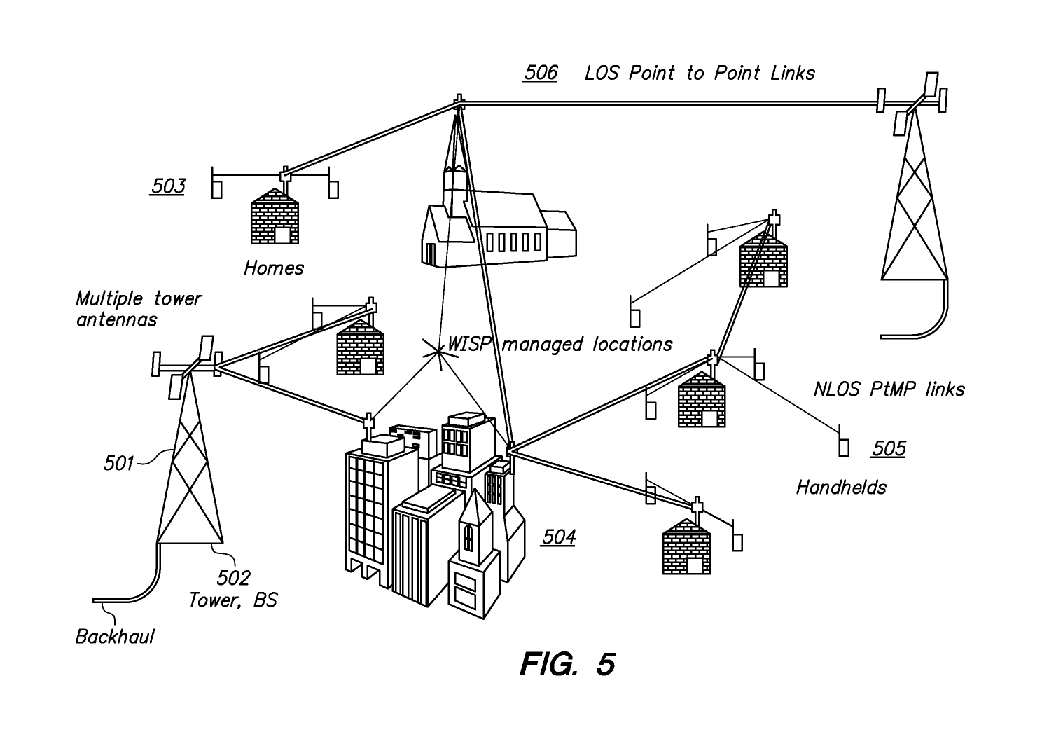

FIG. 5 illustrates a mesh network in accordance with an embodiment of the present invention. As shown in FIG. 5, a backhaul 501 is connected to tower 502 having multiple antennas. The antennas of the tower 502 can communicate with homes 503, businesses 504, and mobile devices 505 via a mesh to network of wireless links 506.

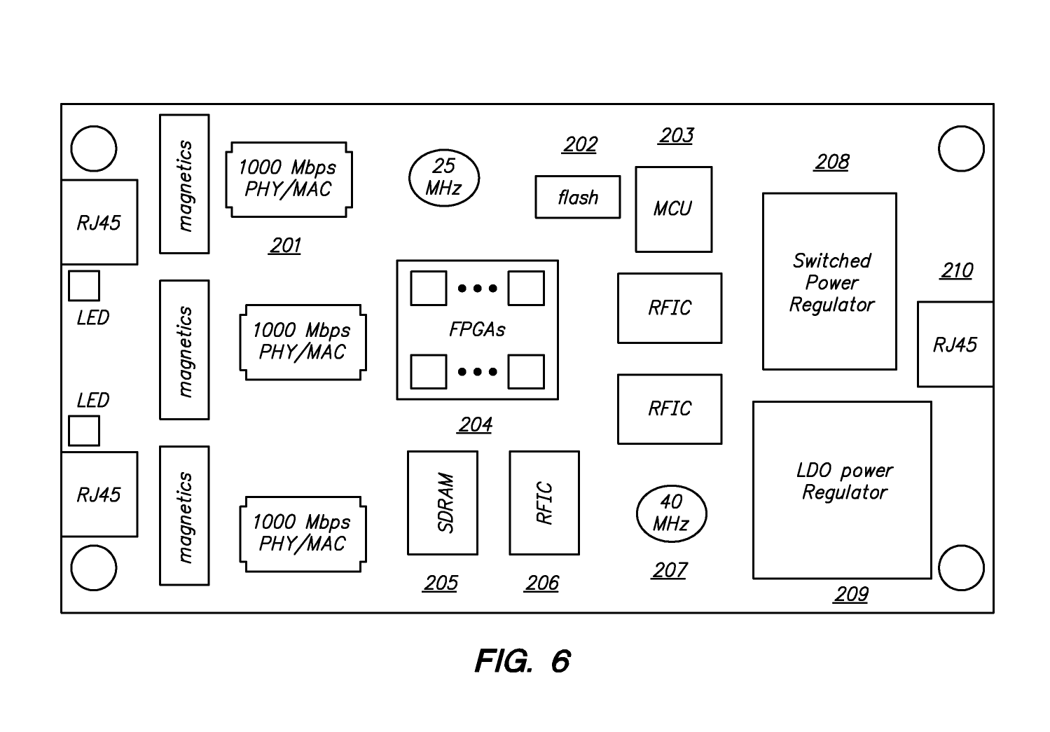

FIG. 6 illustrates hardware board level components that make up a typical transmitter or receiver in accordance with an embodiment of the present invention. Referring to FIG. 6, a radio system includes an Ethernet connection of an RJ45 port 210, Ethernet PHY, MAC chips 201 and magnetics core, field programmable gate array (FPGA) or application specific integrated circuit (ASIC) 204, digital-to-analog converters (DAC), analog-to-digital converters (ADC), radio-frequency integrated circuits (RFIC) 206, data storage, such as synchronous dynamic random access memory (SDRAM) 205, a processor such as a micro controller unit (MCU) 203 and a clock generation circuit. In addition, a switching power regulator 208 or a low dropout regulator 209 can be provided for power generation. Functionality described herein can physically reside in the FPGA or ASIC and the MCU in form of logic circuits or machine code derived from higher level code that implements the functions of the various signal processing and networking algorithms as well as control loops and algorithms described herein.

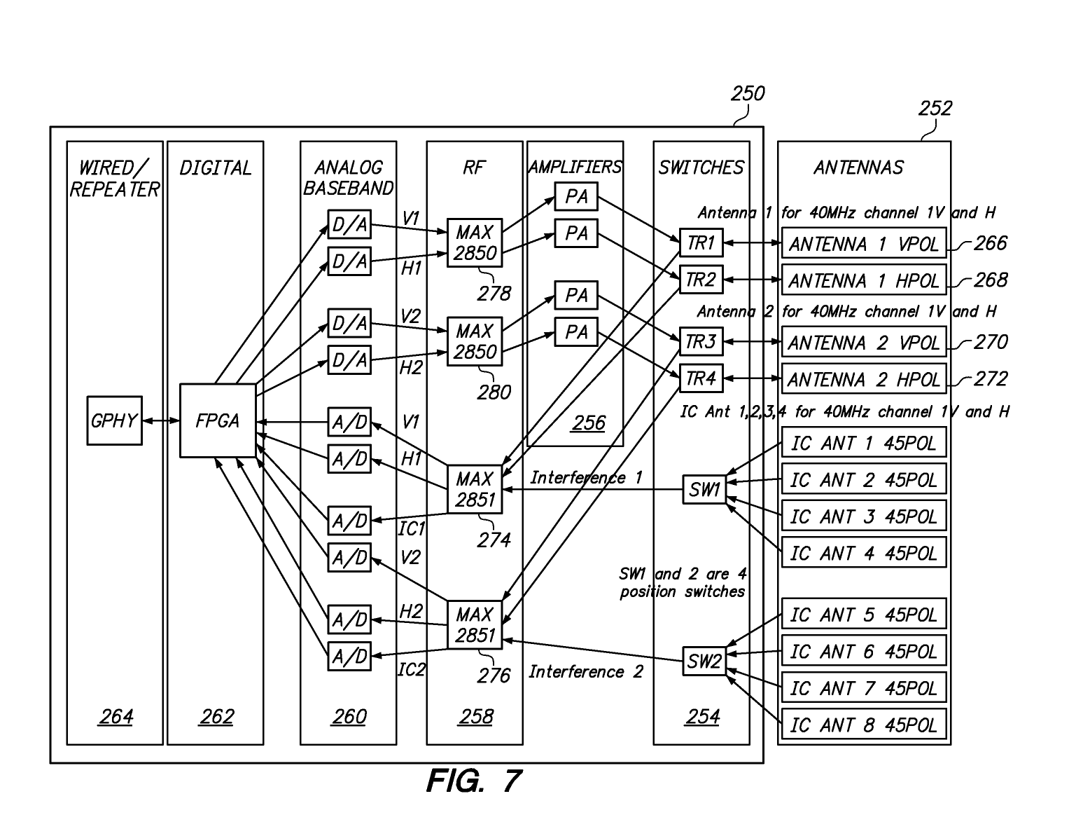

FIG. 7 illustrates signal flow within a radio transceiver in accordance with an embodiment in accordance with an embodiment of the present invention. This transceiver can be employed, for example, in PTP backhaul applications. As shown in FIG. 7, a radio transceiver 250 is coupled to a bank of antennas 252. The transceiver 250 includes a switch bank 254, amplifiers 256, a radio frequency processing section 258, an analog-to-digital baseband processing section 260, a digital processing section 262 and a network interface 264. In a receive path for a first channel, vertical and horizontal polarized antennas 266 and 268 receive a first wireless signal. And, in a receive path for a second channel, vertical and horizontal polarized antennas 270 and 272 receive a second wireless signal. Switches TR1 and TR2 route the first received signal to an RF integrated circuit processor 274 while switches TR3 and TR4 route the second received signal to an RF integrated circuit processor 276. The RF processors convert the received RF signals to baseband. The baseband signals are then sampled by analog-to-digital converters in the analog-to-digital baseband processing section 260. The digital samples are then processed by the digital signal processor 262. The digital signal processor 262 appropriately formats the received signal data for communication to a network via the interface 264.

In a transmit path, data to be communicated in the two channels via the radio transceiver 250 can be received from a network via the network interface 264 and processed by the digital signal processing section 262. Digital baseband signals from the digital signal processing section 262 for the vertical and horizontal polarizations for each of the two channels are then converted to analog signals by digital-to-analog converters of the analog-to-digital baseband processing section 260. The vertical and horizontal polarized analog signals for the first channel can be routed to RF integrated circuit processor 278 while the vertical and horizontal polarized analog signals for the second channel can be routed to RF integrated circuit processor 280. The signals to be transmitted can then be amplified by amplifiers 256 and routed to the appropriate transmit antennas 252 via switches TR1, TR2, TR3 and TR4.

Also shown in FIG. 7 are interference signal paths. Antennas 252 can also receive one or more interfering signals. For example, two interfering signals are shown in FIG. 7. The interfering signals can be routed by switches SW1 and SW2 to RF processors 274 and 275, converted to digital samples by analog-to-digital converters 260 and provided to the digital signal processor 262. The digital signal processor 262 uses the received interfering signals in an attempt to subtract estimated interfering signals from the desired signals. The digital signal processor 262 is preferably implemented in hardware, for example, as a field programmable gate array (FPGA), application specific integrated circuit (ASIC) or other hardware device or devices.

In an embodiment, the interfering signals are received during periods when the desired signals are not being transmitted such as during switching periods. The interfering signals are then correlated to the desired signals and subtracted from the received desired signals in order to obtain an estimate of the transmitted desired signals in absence of the inference.

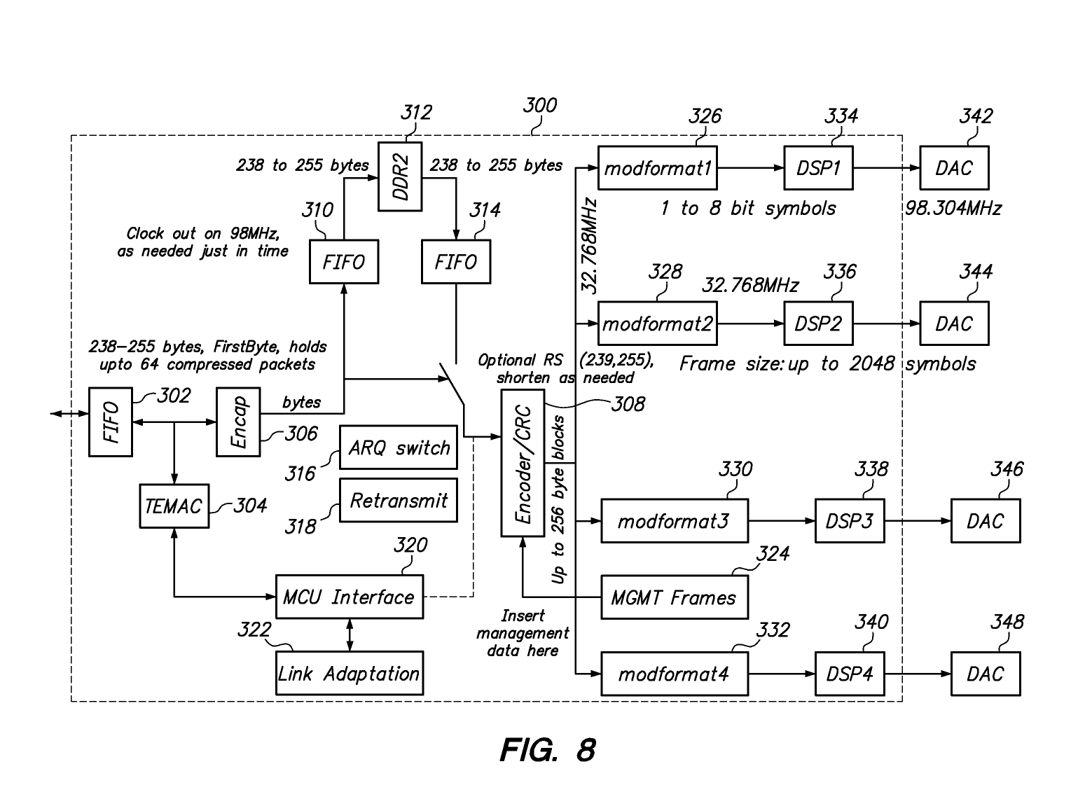

FIG. 8 illustrates a block schematic diagram of a radio transmitter 300 in accordance with an embodiment of the present invention. The transmitter 300 can be included in the digital processing section 262 of the radio transceiver 250 illustrated in FIG. 7. Data from a typical 1 Gbps Ethernet connection is provided to the transmitter 300. This data can be rate adapted to an available aggregate wireless channel capacity through a series of transformations. Ethernet data packets are received into a buffer 302 (e.g. from the network interface 264 of FIG. 7).The Ethernet packets are then converted to a synchronous fixed rate signal. This can be accomplised using a block formatter or encapsulator which outputs blocks of constant rate bytes that are suited for block coding using for example a Reed Solomon codec and interleaving and scrambling. More particularly, Ethernet data packets are processed by a tri-mode Ethernet media access controller (TEMAC) 304 that identifies payload data from the packets. An encapsulation block 306 de-encapsulates the payload data. The payload data can then be provided to an encoder 308 for encoding. The encoder 308 can be, for example, a cyclic redundancy check (CRC) encoder. As shown in FIG. 8, the payload data can be routed to a data storage prior to encoding by the encoder 308. More particularly, the payload data can be routed to a buffer 310 and stored in memory 312. The memory 312 can be, for example, a double data rate synchronous dynamic random-access memory (DDR2) or other type of memory. The blocks can be stored in a large memory such as DDR Ram outside the FPGA. Upon retrieval from the memory 312, the data can be routed to a buffer 314 prior to encoding by encoder 308. The memory 312 and buffers 310, 314 preferably provide a constant data rate to the encoder 308. An automatic repeat request (ARQ) error control block 316 and retransmit block 318 can be utilized for re-sending missing data or data with detected errors. A micro-controller unit interface (MCU) 320 and link adaptation block 322 can be utilized for controlling the process of converting the Ethernet data packets into a constant rate data stream. Management frames can be inserted by a block 324.

After encoding, encoded data blocks are sent to a module or modules 326, 328, 330, 332 that load each of a plurality of wireless channels with the proportional amount of data that it can carry. This level of adaptability can be helpful when multiple channels are aggregated. As shown in FIG. 8, four channels are provided though it will be apparent that a different number of channels can be utilized. DSP processors 334, 336, 338, 340 then take the bytes in each channel FIFO and convert them to symbols suited for transmission. A further step in signal processing can be a channel filter such as a square root raised cosine filter. There may be provided a pre cross polarization interference canceller in the transmitter itself so that the receiver gets a nominally orthogonal polarized signal pair. Digital to analog converters 342, 344, 346 and 348 can then convert the data streams to analog signals in preparation for radio transmission.

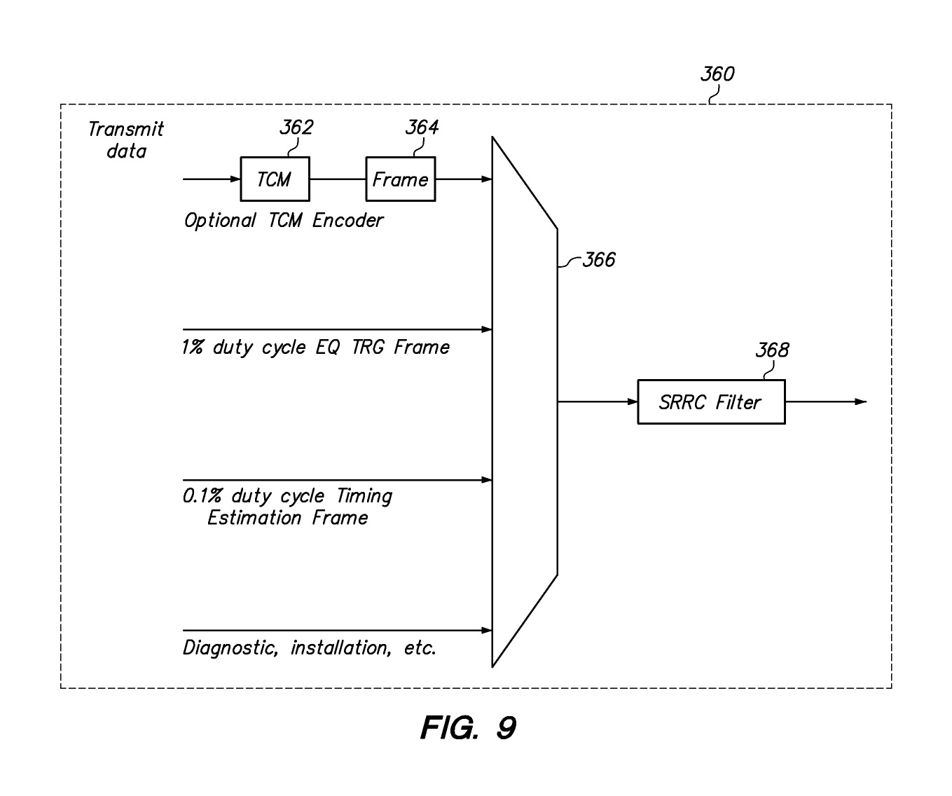

FIG. 9 illustrates a block schematic diagram of a transmit digital signal processor (DSP) in accordance with an embodiment of the present invention. The transmit DSP 360 shown in FIG. 9 can be utilized in place of any of the DSP processors 334, 336, 338 or 340 shown in FIG. 8. Referring to FIG. 9, data to be transmitted can be applied to a trellis code modulation (TCM) block 362 and to a framing block 364. The TCM block 362 is optional and, when included, encodes the incoming data in accordance with TCM encoding. The framing block 364 frames the data in accordance with Ethernet data packets. A multiplexer 366 combined the data from the framing block with additional data, which can include 1% duty cycle TRG frame, 0.1% duty cycle timing estimation frame, and diagnostic information, installation information and so forth. The TRG or training frames provide a control channel between radio systems for passing information such as polarization coordination information, identify optimal modulation techniques for sub carriers, and allocating sub carriers to a nodes in of sectors. In an exemplary implementation, a 13 bit Barker sequence is convolved with a 4 bit Barker sequence to get a unique preamble signal for training the receiver for timing, frequency and equalization. All 8 signals from the 8 antennas are also multiplexed into a single estimator which implements gain, frequency, timing and equalization. This allows a very compact design that is implemented in far fewer resources inside the FPGA. Data signal frames output from the multiplexer can be filtered by a matched transmit filter 368 such as a root raised cosine filter (SRRC) filter. The output from the filter 368 can be applied to any of the digital to analog converters 342, 344, 346 and 348 of FIG. 8.

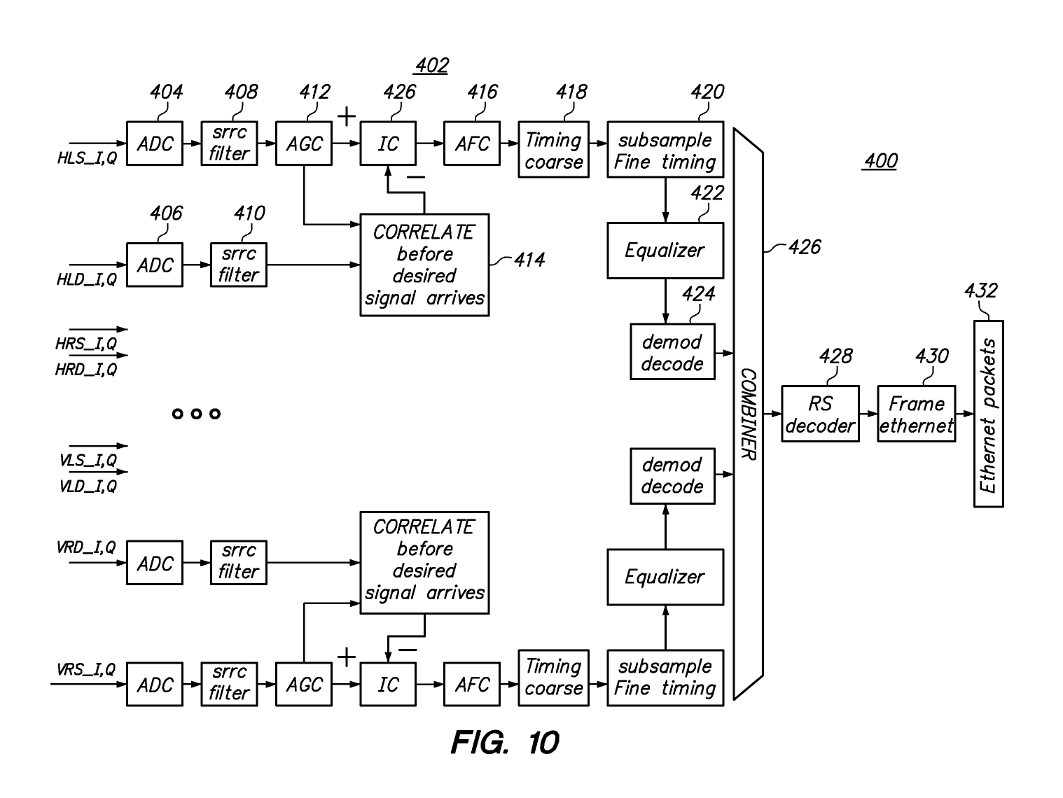

FIG. 10 illustrates a block schematic diagram of a radio receiver 400 in accordance with an embodiment of the present invention. The radio receiver 400 can be included in the digital processing section 262 of the radio transceiver 250 illustrated in FIG. 7. The receiver 400 receives signals from a multiple antenna system (MIMO). These received signals can include horizontal (H) and vertical (V) polarization from corresponding antenna elements, as well as signals from left (L) and right (R) oriented antennas, sum (S) and difference (D) signals as well as both in-phase and quadrature (I and Q) signal components. Thus, as shown in FIG. 10, the received signals are signified with the letters H or V, L or R, S or D and I, Q to identify their corresponding antenna configuration. While eight signals are illustrated, it will be apparent that a different number can be employed.

As shown in FIG. 10, each pair of sum and difference signals are processed by a separate corresponding digital signal processing chain. Specifically, horizontal, left, sum, in-phase and quadrature sum and difference signals (identified in FIG. 10 as “HLS_I,Q” and “HLS_I,Q) are applied to a first DSP processing chain. Similarly, additional pairs of sum and difference signals are applied to respective processing chains. Not all of the DSP processing chains are illustrated in FIG. 10 through processing chain 402 is representative. Within the processing chain 402, the HLS_I,Q signal is sampled by an analog to digital (ADC) converter 404, while the HLD_I,Q signal is sampled by an analog to digital (ADC) converter 406. Next the samples of the pair of sum and difference signals are applied to pulse shaping filters 408, 401 such as a square root raised cosine filter (SRRC). These would be typically matched to the corresponding transmitter side filter (e.g. filter 368 of FIG. 9). After this, the signal is sent to an automatic gain control (AGC) loop 412 that adjusts the gain of the signal using the gain range available in the analog radio section, as well as dynamic range inside the digital processor 262 domain. This gain adjusted signal then goes to a correlator 414 for timing lock, and for automatic frequency correction. The correlator 414 output can typically be that arising from a multiple (convolved 13 bit and 4 bit Barker for example) Barker sequence signal. This output of the correlator 414 can be used for auto frequency correction (AFC) 416, timing correction 418, 420 and equalization 422. The adjusted signal is sent to a demodulator 424. In the system, prior to these loops, there may be an interference cancellation loop 426. The interference signal can be estimated during the time that the receiver is on but the desired far away signal has still not reached the radio. A typical 10 km link can have as much as 66 micro seconds of such dead time during which only the interfering signal is received. The interference signal received on the desired channel radio (sum port in FIG. 10) is correlated to that received on the difference channel radio. The correlation coefficients are used during data reception to cancel interference. Once a clean interference free signal is obtained, conventional signal processing steps such as demodulation, decoding and deinterleaving, etc. can take place. As shown in FIG. 10, a combiner 426 combines the several received signal processing chains. A Reed-Solomon decoder 428 can perform decoding. A framing block 430 can frame the data which is then packetized into Ethernet packets in block 432. The final packetization of Ethernet frames takes multiple blocks of data received wirelessly. These packets are then sent out to the Ethernet port or switch in the system e.g., via network interface 264 (FIG. 7).

Interference Cancelation

Estimation of the signal properties of interference is done after the receiver turns on (switches from transmit to receive) but before the desired signal arrives from the remote unit. The typical duration of estimation cycle is 10 to 200 microseconds which corresponds to 1 to 20 miles round trip delay for electromagnetic signals in air medium. This approach ensures that a weak interference signal can be estimated and cancelled without noise due to the large desired signal. In cases where the interference is dominant, one can continue the interference estimation in the same manner during the entire receive cycle, or even have the transmitter pause in the middle periodically, allowing a quiet period for interference sensing or estimation

During estimation, a three multiplier based complex multiply and accumulate module 414 in the digital processor 262 correlates the signals of the sum and difference (eg. HLS and HLD) antenna ports. The complex conjugate of the difference signal is used for this. Also estimated is the variance of the interference signal.

By dividing the correlation result by the variance term, a normalized interference coefficient is derived. This is used during receive cycle after the desired signal starts to arrive, to scale the signal measured on the interference channel and subtracting the resulting interference estimate. Since the difference port extends a null toward the desired link direction, the signal on these ports is predominantly interference and so there is very little distortion in the desired signal as a result of these operations.

All these interference cancelation procedures work at line speed in the digital processor 262 and take up parallel resources. In the example case of a signal with 33 MHz bandwidth sampled at 100 MHz, the complex multiply and accumulate takes 3 multipliers, 5 adders and 1 accumulator. The variance estimator can share a single multiplier and one accumulator if it is assumed that the interference signal has a fixed variance or if the variance estimate can be carried during actual signal reception cycle.

The AGC (gain control) 412 is preferably performed before interference cancellation 414 so that the A/D and radio remain in a linear region of operation even though the interference signal can actually be stronger than the desired signal.

The approach outlined above can cancel interference that is up to 20 dB higher than the desired signal and bring the interference level to 30 dB below the signal, so that 256 QAM (highest modulation used in our system) with coding can be reliably used. Very close to 1 Gbps throughput can be expected under very high interference levels using these interference cancelation methods. Furthermore an interferer of the same power as the distant (10 km) desired transmitter, but only a meter away from the receiving unit can be cancelled to allow 256 QAM (1 Gbps in our exemplary system) signal from the distant unit. This corresponds to a total of 110 dB or 11 orders of magnitude reduction in the interference signal relative to the desired signal.

Channel Estimation

One of the components in accordance with certain embodiments of the present invention is a channel estimation algorithm and its performance. An embodiment of a channel estimation technique used is described below.

Assuming that OFDM is used as the underlying modulation technique, let the system parameters be: occupied bandwidth=20 MHz, delay spread expected <3 microseconds, adaptive modulation technique used—4, 16 and 64 QAM, Doppler spread=5 Hz, required S/(N+I) of 20 dB for 64 QAM. Then one can design an OFDM system with guard interval of 4 microseconds, OFDM symbol duration of 17 microseconds with 256 sub carriers. The channel estimation technique relies on the clients sending a special OFDM symbol—the equalization symbol every 4 milliseconds. The clients in each sector take turns sequentially sending their equalization symbols. The base station (e.g. connected to tower 502 in FIG. 5) receives each such symbol on all its sector antennas and is able to estimate the channel condition on each sub carrier of each client on each antenna. Assume that there are 12 sectors and that polarization is not being used in this example. In order to have a reliable estimate, the clients can transmit higher power or simultaneously transmit one symbol in 12 adjacent sub carriers. So effectively, a single arriving symbol is actually OFDMA of the 12 clients. Now the clients can put out 12 times the power per sub carrier. 12 symbols are taken for completing the channel estimation from all the 12 clients on all the sector antennas. Now the base station has enough information to pre-distort each transmit sector signal by injecting the right amount of interference from the other sector signals. The overhead of channel estimation in this case is 12 symbols out of 4 milliseconds, which translates to 5% approximately. Apart from timing and frequency synchronization which can be done once a 100 millisecond interval or longer, there need be no other medium level overhead of transmission. This is as opposed to conventional systems where the overhead for channel estimation can be much larger, for example 10 to 20% in 802.11. An additional benefit from this type of channel estimation is that the base station can optimally modulate each sub carrier with a suitable modulation scheme. For example, if the channel shows excellent equalization signal on a particular sub carrier, perhaps 64-QAM can be used giving 6 bits per cycle on that sub carrier. On the other hand if the channel is particularly bad to the point that there is no signal received on that sub carrier (i.e. deep fade), the base station can skip over that sub carrier altogether. Similarly thresholds can be set for the other two intermediate modulation schemes viz. 16-QAM and QPSK. This level of adaptive modulation can give a significant improvement in channel capacity separately or together with other techniques (e.g. interference cancelation) described herein especially in scattering environments.

The increase in channel power in each sub carrier by using OFDMA on the equalization or channel estimation symbols is notable. Higher signal power results in more accurate channel estimation that ultimately affects the entire system performance.

This particular embodiment described herein involves the use of OFDM and OFDMA techniques. It should also be noted that embodiments of the present invention can be used irrespective of the underlying standard or protocol of communication. While it certainly is easier to implement a scalable system with the full benefit of improvements described herein, in a proprietary embodiment, it is possible to implement such improvements on top of current standards such as 802.11. The OFDM and OFDMA methods presented in this description apply on top of the rest of the physical layer, its use can be limited to getting the base station information about the channel estimates of all the sector clients. In case of standards based systems such as those using 802.11b, the base station front end baseband—where embodiments of the present invention can be implemented—processes the acknowledgements or RTS packets or in general any uplink packet from the client to the base station, using an OFDM processing engine, gathers channel response or estimates on each of the defined sub carriers, and uses them to predistort the sector signal appropriately. Similar embodiments can be derived by one of ordinary skill in this art for other standards based systems such as those employing HSDPA (3G) or 802.16 (WiMax).

One can also use single carrier techniques for implementing embodiments of the present invention into other systems. In one such embodiment, Ethernet packets can be framed into constant bit rate frames, which are split into multiple streams each of which modulates a single carrier. A suitable pair of DAC and ADCs convert the signals from digital to analog and vice versa. The baseband analog signals are then converted to and from a desired RF carrier frequency. By using an RF combiner, several such single carriers are added together before the antenna. On the receiver side, a matched square root raised cosine filter, decision feedback equalizer, demodulator, timing and frequency and gain control loops convert the analog signal into digital data which then can be decoded (for example with a Reed Solomon decoder if such an encoder was used), the byte stream can be combined from all the carriers and then sent to a Ethernet packet framer.

Physical Layer

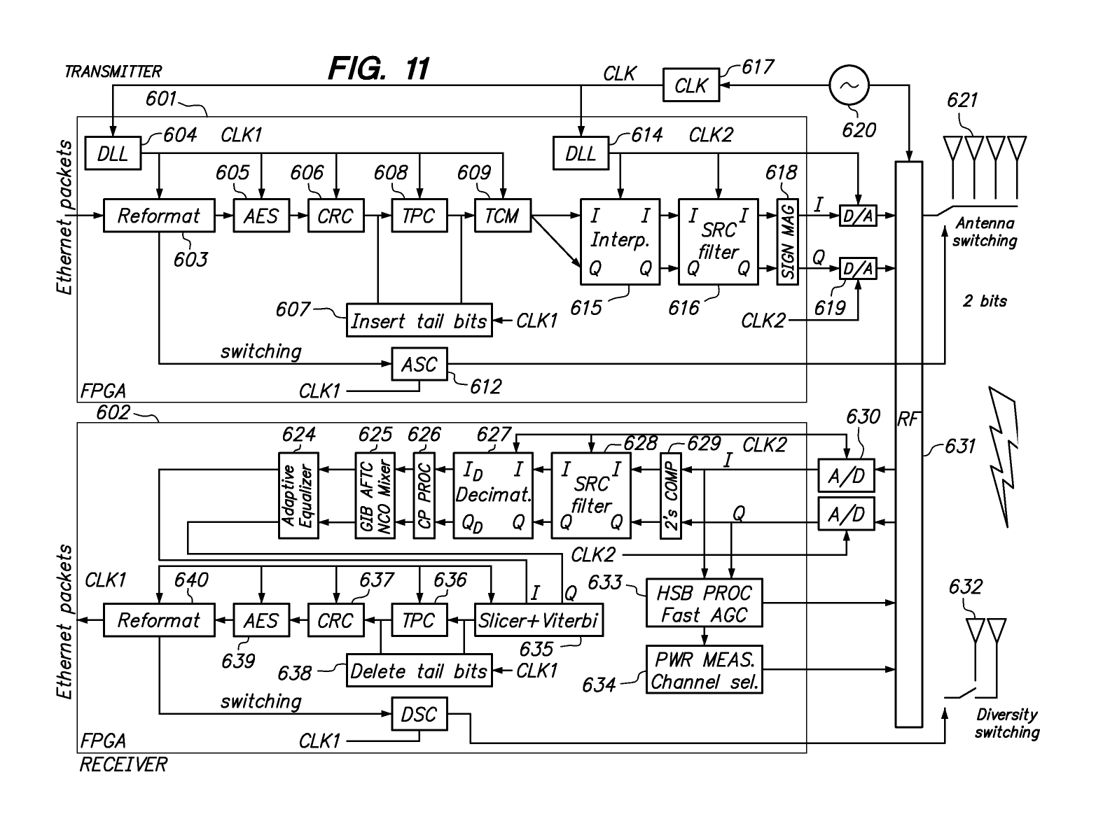

FIG. 11 illustrates a signal processing block schematic diagram of a typical transmitter and receiver using OFDM techniques in accordance with an embodiment of the present invention. FIG. 11 shows the physical layer representative of a single channel though it will be understood that modifications can be made, for example, to extend the system for multiple channels. A transmitter section 601 is comparable to the transmitter 300 of FIG. 8, while a receiver section 602 is comparable to the receiver 400 of FIG. 10. Thus, the transmitter section 601 and/or elements thereof can be interchanged with the transmitter 300 and/or elements thereof. Similarly, the receiver section 602 and/or elements thereof can be interchanged with the receiver 400 and/or elements thereof.

Baseband Block Processing Components

The transmitter section 601 of a base station or client includes an Ethernet interface, packets from which can be anywhere from 56 bytes to 65536 bytes (Jumbo packets). This is followed by a reformatting block 603 that breaks up the Ethernet packets into sizes appropriate for transmission over a wireless medium. Then an encryption algorithm such as advanced encryption standard (AES) can be employed in a block 605 to better secure communications. Following this, a CRC checksum can be added along with MAC level headers in block 606. Then the entire packet can be optionally subject to channel forward error correction encoding (FEC) in block 608 where in the packet is made insensitive to a limited number of bit errors, such as by use of turbo product codes (TPC). Tail bits can be inserted at block 607. Adaptive modulation can be performed in a block 609. The modulation scheme used in block 609 can be a trellis coded modulation (TCM) scheme that divides the constellation by 3 levels and employs a strong convolutional (2,1,7) or turbo codec to obtain a coding gain of up to 9 dB over all. The TCM symbols can be sent through an adaptive modulator in block 609, and then filtered by a pulse shaping filter such as a square root raised cosine filter (SRC) 616. A sign magnitude converter 618 can also be employed. The samples are then sent to a pair of DACs 619 and to an analog processor which can be a radio-frequency integrated circuit (RFIC) 631 and which can also be a direct conversion chip. The RFIC 631 preferably performs baseband amplification, filtering and upconverting to RF in a single stage, gain control and then filtering followed by a power amplification stage. The signal then passes through a Transmit/Receive switch and a balun to the antenna 621 for transmission. An oscillator 620 and clock signal generator 617 can generate clock signals for use by delay lock loops 604 and 614 which can control timing in the transmit processing path. On the receive side, the signal goes through the same antenna 621 and switch, in through a bandpass filter, low noise amplifier, gain control stage and then into a mixer where it is brought down to baseband. These steps can be performed by the RFIC 631. This can be followed by further filtering and gain control and conversion from analog to digital is performed by analog to digital converters 630. The digital samples then are filtered in blocks 629 (2's complement), 628 (SRC filter), 627 (decimation), and the cyclic prefix removed in block 626. An automatic frequency and timing correction (ATFC) algorithm is applied in block 625. At the same time, an automatic gain control circuit 633, 634 sets the signal level appropriately for the other subsequent blocks. Following the AFTC, adaptive equalization is performed in block 624 to clean up the signal of all the channel impairments. The demodulation technique used depends on the adaptive modulation algorithm used. After demodulation the raw bits and soft decision samples are sent to the channel codec (in or after TCM). The codec processing essentially mirrors processing in the transmitter 601, and can include slicer and Viterbi processing block 635, error correction decoding block 636, CRC checksum processing block 637 and advanced encryption standard (AES) block 639. The corrected bits are then packaged into bytes and packets that are decrypted and reformatted to Ethernet packets in block 640. These are finally sent to the host assuming the Ethernet CRC passes. If not, the transmitter is informed through a negative acknowledgement and the packet is rescheduled for transmission due to errors.

Also shown in FIG. 11 is a diversity switching scheme employing diversity antenna 632.

RF and Analog Circuitry

The radio frequency portion of a typical embodiment of the present invention performs the functions of filtering, amplification and mixing. In the transmission path, a task performed is the conversion of the digital samples into analog voltage or current based signals. This is achieved by the use of a pair of digital to analog converters or DACs 619 (FIG. 11). Typical DACs that can perform this task while preserving signal integrity for the present invention and broadband wireless operations in general, have 10 bits resolution and run 40 or 80 MHz sampling rates. The pair of baseband DAC analog output signals are called I for in-phase and Q for quadrature components. These I and Q signals enter the RFIC 631 and are filtered at baseband and amplified before being fed to the single stage mixer which upconverts the signal to the appropriate radio frequency. Frequency channel control is done through changing the voltage of a VCO synthesizer 620 used to generate the carrier LO tone. The mixer output residing at RF is again filtered, gain controlled and power amplified. The final amplified signal is then fed through a transmit/receive switch in case of half duplex operation, to the antenna 621 for transmission. It is expected to have S/(N+D) around 40 dB at the output of the transmitter. Power levels output can vary from 50 mW for unlicensed operations to 100 W or higher for licensed band operations. Typical antenna gains in the microwave frequencies range from 2 to 30 dBi.

In the receive path, the antenna excitation signals are detected and amplified by a low noise amplifier (LNA) after passing through the switch and a front end RF filter of the RFIC 631. This LNA determines the noise entering the system as well. It is then followed by a gain adjustment stage and the signal then is mixed down in a single stage to baseband using the mixer. The baseband signal is further amplified, filtered before being sent out of the RFIC 631 in I and Q forms. These are digitally sampled by a pair of analog to digital converters (ADCs) 630 and the digital samples are sent to a logic processor such as an ASIC or FPGA (e.g. digital processor 262 of FIG. 7).

Automatic Gain Control

There are three parameters that need to be synchronized between the transmitter and receiver in a typical broadband wireless radio. The receiver usually implements all these though it can also be done entirely at the transmitter or by both the transmitter and receiver. The first of these is power level adjustment usually done through an automatic gain control circuit (e.g. AGC 633). It is responsible for adjusting the RF gain control stages in the receive path. A reference known signal such as an equalization control channel symbol is used to compute the gain control settings needed for the data bearing signal to be successfully decoded. These gain control settings are then applied to the RFIC 631. A simple way of closed loop adjustment can involve monitoring the number of times the most significant bit of the samples is set, which signifies the signal level. This can be mapped via a table lookup to the actual registers that are set in the RFIC 631 register space to adjust the gain.

There is also a need for gain control on the transmit side. For example, in order to reduce overall interference the base station can set the transmit power levels of all the sector signals to be the same. To do this, the ASIC or FPGA of the system (e.g. digital processor 262) can set the variable gain amplifier's registers of the RFIC 631 to appropriate values.

Automatic Frequency and Timing Control

In OFDM embodiments, it can contribute to good system performance to have an accurate frequency and timing synchronization. While timing is less critical, usually one can achieve both using the same algorithms.

One method of frequency synchronization is by detecting the difference in the crystal frequency of the transmitter and the receiver. Frequency offset is essentially caused by this difference, and so is timing since the ASIC or FPGA (e.g. digital processor 262) also typically derive their clocks from this crystal.

A method for estimating the difference can involve the transmitter sending known timing symbols at deterministic intervals in time—e.g. 64 milliseconds apart. The receiver opens a window around this interval and searches for the timing symbol. By noting the difference of its local counter and the deterministic interval, the receiver can estimate the clock and therefore crystal frequency difference. This can then be mapped to a frequency offset in a straightforward manner and the offset can be used to drive a tone generator.

Modulation

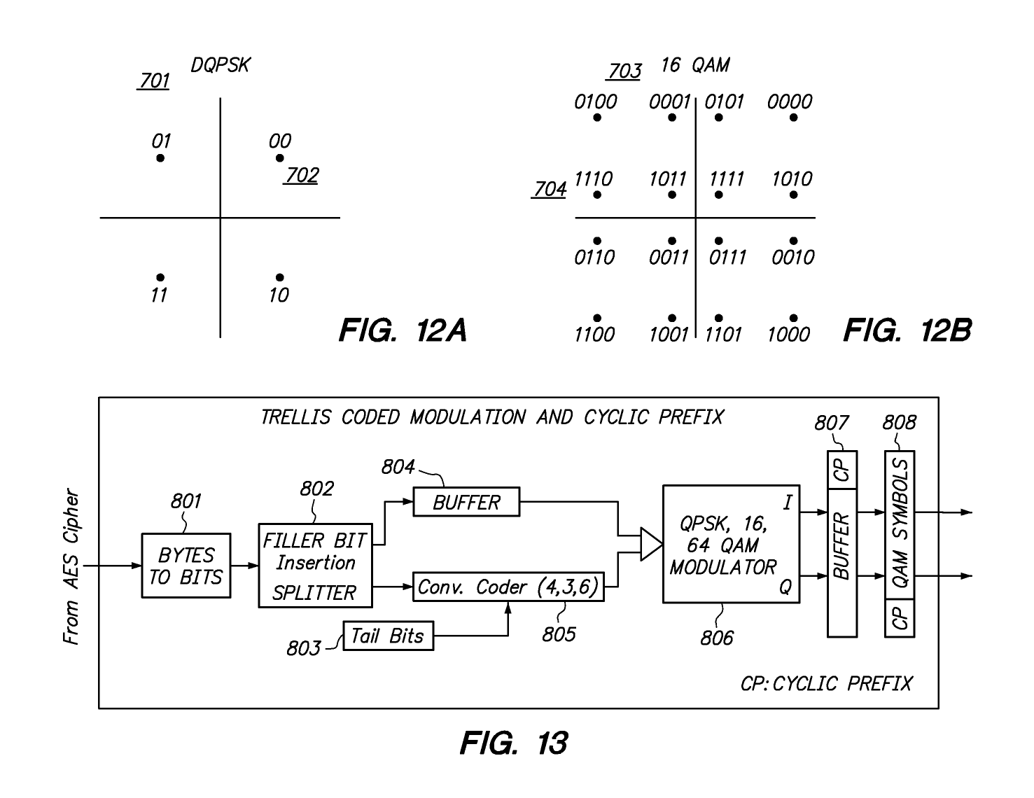

FIGS. 12A-B illustrate typical modulation symbol constellations in accordance with embodiments of the present invention. Although not a limitation of the system, the modulated symbol can be taken from 4 point (QPSK) to 256 point (256 QAM) constellations. Typically, these constellations are Gray encoded and Trellis coded (TCM). The constellations can be utilized in preparing data for transmission.

FIG. 13 illustrates a trellis coded modulation (TCM) technique in accordance with an embodiment of the present invention. FIG. 13 illustrates the modulation block 362 of FIG. 9 in more detail. Specifically, bytes to bits conversion 801 can be performed by modules 326, 328, 330, 332 (FIG. 8). The output bits are applied to a filler bit insertion and splitter block 802 and then to buffer 804 and to convolutional encoder 805. Tail bits can be inserted at block 803. A modulator 806 performs the modulation (e.g., QPSK, 16 QAM, 64 QAM). The modulated data is then applied to a buffer 807 and symbol generator block 808. The symbols from symbol generator block 808 can be applied to framing block 364 of FIG. 9.

Such a modulation scheme benefits from extra channel coding gain at very little complexity cost. Constellations similar to those of FIGS. 12A-B can be used adaptively in the TCM module (e.g. modulation block 362 of FIG. 9). These constellations are broken down into groups. The input data bit stream is also broken up so that a few bits (1 or 2 or 3) are used to select the group index of constellation subset used while the rest of the bits are used to modulate the remaining bits to the constellation points in the specific subset. The groups are chosen so that the member constellation points are as far from each other as possible. The bits used to choose the specific subset are output from a strong codec—for example (2, 1, 7) convolutional code or a turbo code. The coding gain from these can range from 6 to 9 dB. The constellation subsets can result in separations representing 6 to 9 dB as well. Hence using TCM, one can expect overall coding gains of 6 to 9 dB while dropping data rate only marginally.

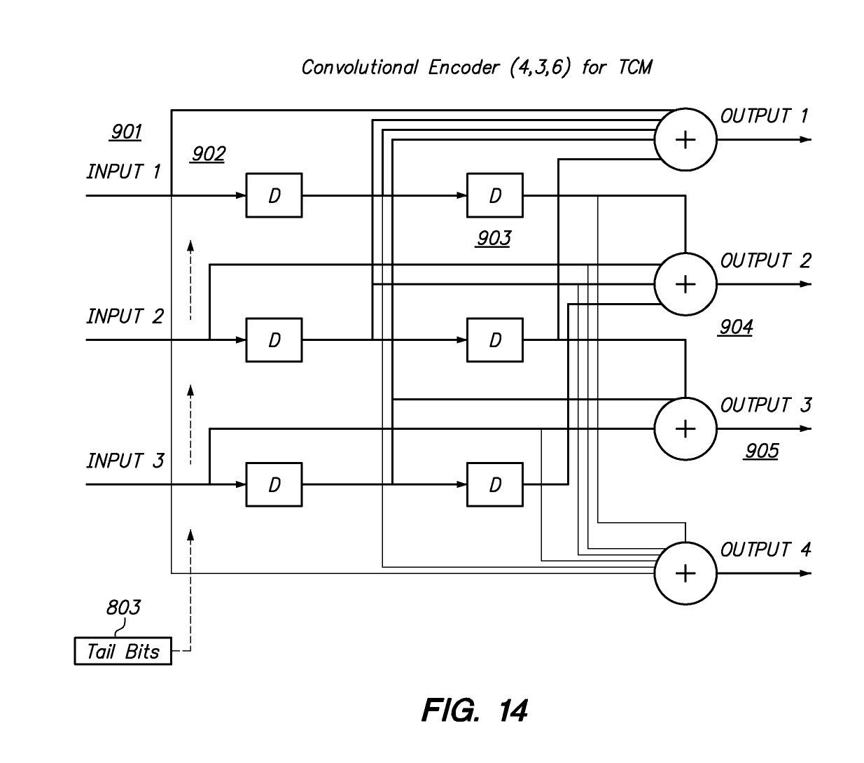

FIG. 14 illustrates a block schematic diagram of a convolutional encoder that can be employed in a digital signal processor in accordance with an embodiment of the present invention. For example, the encoder of FIG. 14 can be employed as the encoder 805 of FIG. 13. The codec used in the example system is a (2, 1, 5) encoder/Viterbi decoder with soft decisions. As shown in FIG. 14, bits are applied to inputs 901. Delay blocks (or shift registers) 902, 903 and summation blocks 904 combine the bits in accordance with the coding and output results at outputs 905.

Equalization

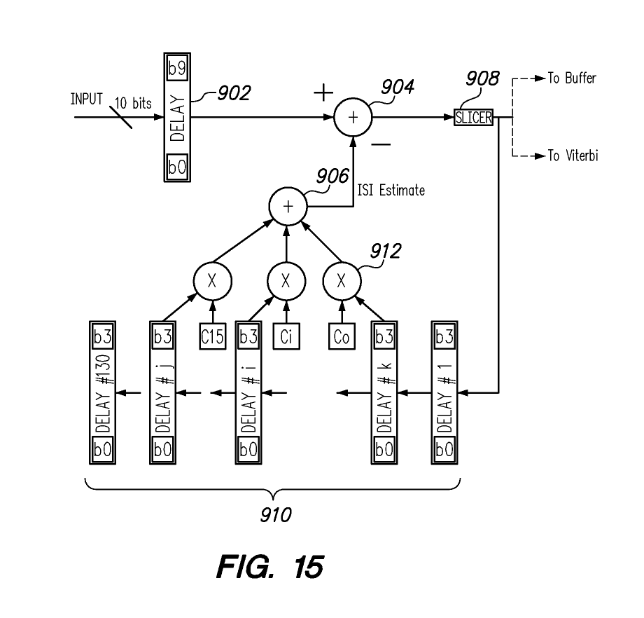

FIG. 15 illustrates an adaptive equalizer used to remove channel distortions at a receiver in accordance with an embodiment of the present invention. The adaptive equalizer of FIG. 15 can be employed as the adaptive equalizer 422 of FIG. 10 and the adaptive equalizer 624 of FIG. 11. Referring to FIG. 15, the received signal needs to be equalized to get rid of the channel impairments. In an embodiment of the present invention, equalization involves a single complex term multiplication per sub carrier. This is so if the channel remains constant across the sub carrier. The multiplicand is determined from the channel estimation procedure. The equalization symbol that the transmitter sends periodically is converted to channel estimates (by removing the equalization symbol itself) which are then stored in a local memory. As shown in FIG. 15, input symbols are applied to a delay block 902 and to a summation block 904. The summation block 904 subtracts an inter symbol interference (ISI) estimate received from a summation block 906 to produce estimated output symbols. The estimated output symbols are applied to a slicer 908 and selected bits applied to delay blocks 910. Bits from delay blocks are combined by multiplication blocks 912 and summed by summation block 906 to produce the ISI estimate.

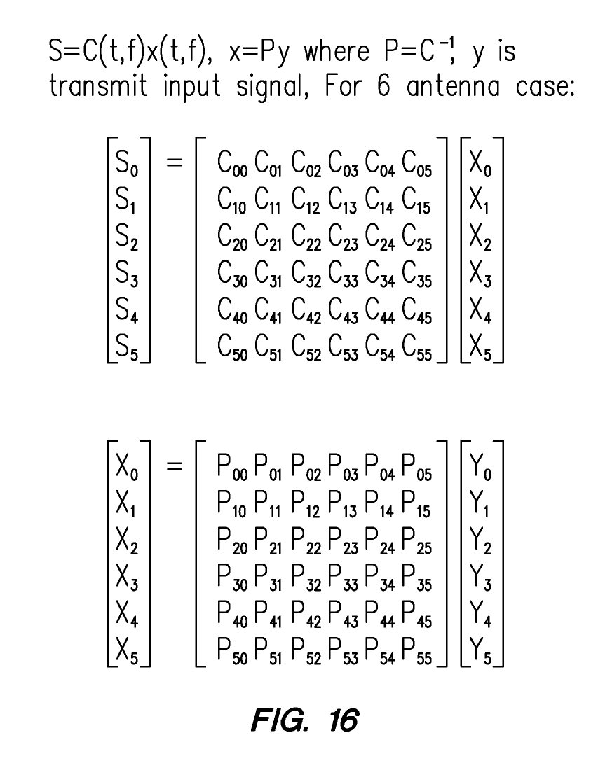

FIG. 16 illustrates a matrix representation of a plurality of interfering signals in accordance with an embodiment of the present invention. The channel matrix needs to be invertible, i.e. the inverse matrix P of C has to exist. In many cases, C can be made sparse and block diagonal. This makes the inverse computation more localized and easier to accomplish in hardware such as an FPGA or ASIC. In a point to point implementation, the matrix can be 8×8 using 8 radios, but when arranged appropriately (desired and interference channel for each polarization and frequency separately), the matrix essentially becomes 2×2 sub matrices arranged along the diagonal. This makes the system easier to implement. In an example antenna design, about 40 dB cross polarization isolation is expected and that is what leads to simplification of the C matrix as a 4 block diagonal 2×2 matrices rather than a 2 4×4 block diagonal matrix. The matrix computation is employed in the feed forward loop involving correlation block 414 of FIG. 10.

Exemplary System Link Analysis

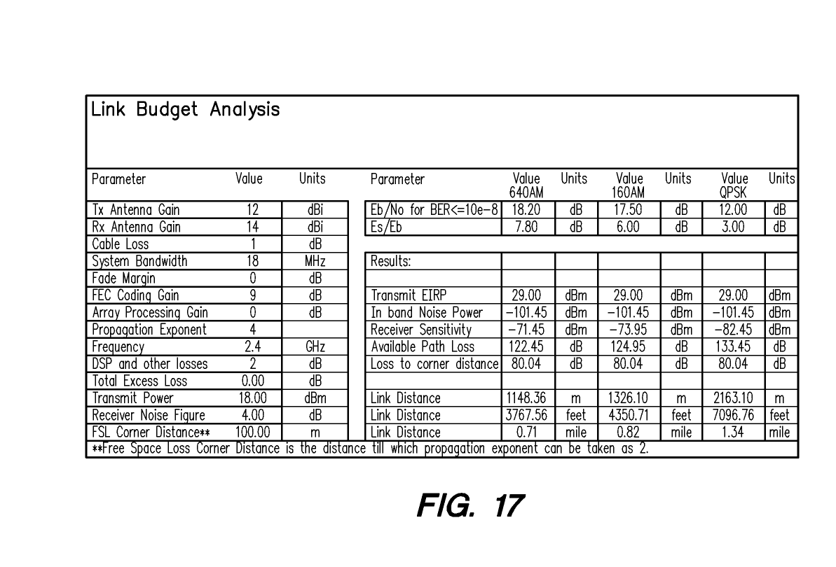

FIG. 17 illustrates a typical link budget analysis of a system in the 2.4 GHz band in accordance with an embodiment of the present invention. Referring to FIG. 17, it can be seen that the link budgets for the present invention based systems are no different than conventional systems without the present invention embodied in them. Assuming operations in the unlicensed 2.4 GHz band, this example indicates that at 17 dB S/N per polarization based channel, the sector clients can decode the signal intended for them at a data rate of 70 Mbps in that channel. Using both polarizations would mean an S/N ratio of 20 dB is required for the client to decode correctly.

As seen in FIG. 17, a typical link would have a maximum of 9 dB channel coding gain through the use of turbo codecs or concatenated codes. With the use of trellis coded modulation and 64-QAM, a data rate of 70 Mbps is achievable using 20 MHz bandwidth channel. Furthermore if both polarizations are used, then per sector client a data rate of 140 Mbps can be realized, while with 12 sectors, 1.68 Gbps capacity can be realized at the base station. Typical scattering environments result in an excess of 20 to 25 dB loss over free space propagation loss to 30 meters, in an indoor environment.

Antenna Systems

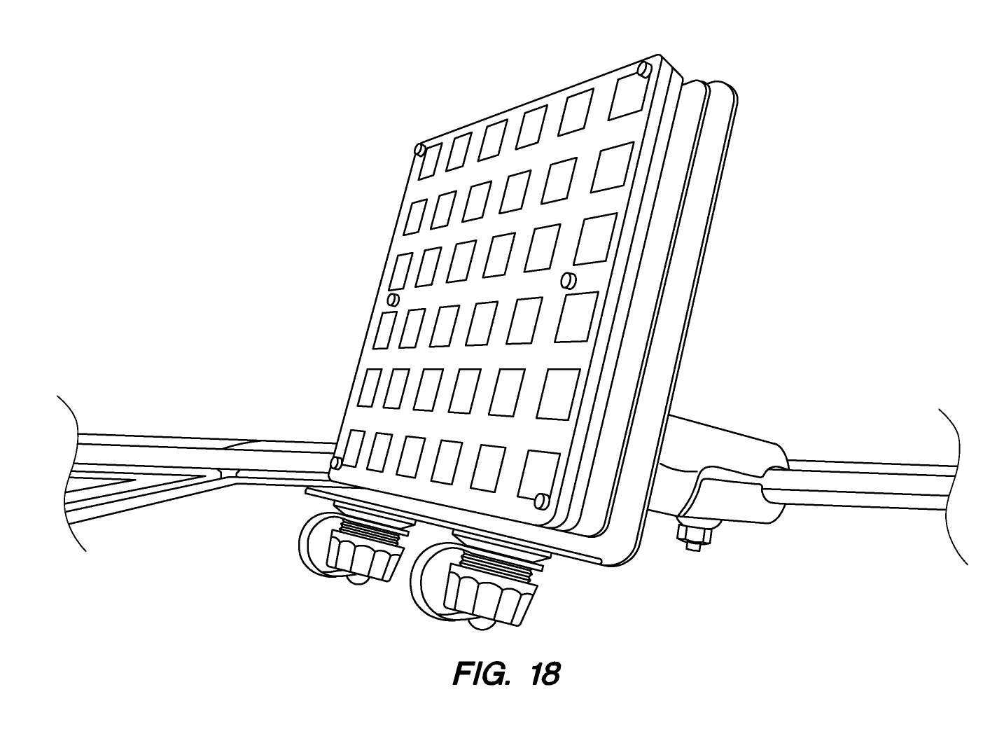

FIG. 18 depicts a typical interference detection and cancellation antenna arrangement that aids in minimizing the maximum interference in the plane of the main high gain antenna in accordance with an embodiment of the present invention. The antenna arrangement is optimally chosen so that the near end interferer (for example one on the same tower), is cancelled the most. From an antenna perspective, the side antennas (interference detection antennas) detect more interference than desired signal since they are facing towards potential interferer signals (note that the desired signal is typically from a highly directional antenna and is very weak if not pointed to the correct narrow direction of the transmitter). On the other hand, the main high gain directional antenna receives more of the desired signal than the side antennas. By appropriately combining these signals at baseband in a digital signal processor (e.g. 262 in FIG. 7) for example, they can be made orthogonal so that the interference can be easily removed from the desired signal. If the ADC resolution it is not sufficient, the receiver may get swamped by a much larger interference signal than desired, and it may clip the entire desired signal away. Typically 10 bit resolution is sufficient to allow cancellation of an interferer of same transmit power as the desired signal, but sitting 1 to 3 meters away from the receiver, while the desired transmitter is 10 km away (for 5.8 GHz implementation, 1 Gbps data rate).

An aspect of interference cancellation embodiments described herein is that the interference cancelation can be successful in cases where the interferer is directly in line with the narrow beam of the desired signal. Such a situation may arise if the interferer is on the same tower as the desired unit but is also talking to another interferer that is on the same other tower that has the second desired unit (i.e. the two links are completely parallel). In such cases, by synchronizing to the time divisional duplex (TDD) timing or frequency divisional duplex (FDD) frequency plan, the problem of interference can be reduced to the near end problem where the interferer is transmitting on the tower at the same time as the distantly located desired transmitter. By doing so, the interference signal is reduced before it hits the antennas because of the difference in direction of arrival and also the MIMO antennas pick up different signal and interference content on each antenna, as previously described. This method of converting the far end parallel link interference to a near end “in the tower plane” interference is particularly useful in congested areas where there may only be a few towers and signals need to go between the towers because of the location of a fiber point of presence or colocation site near or at one of the towers.

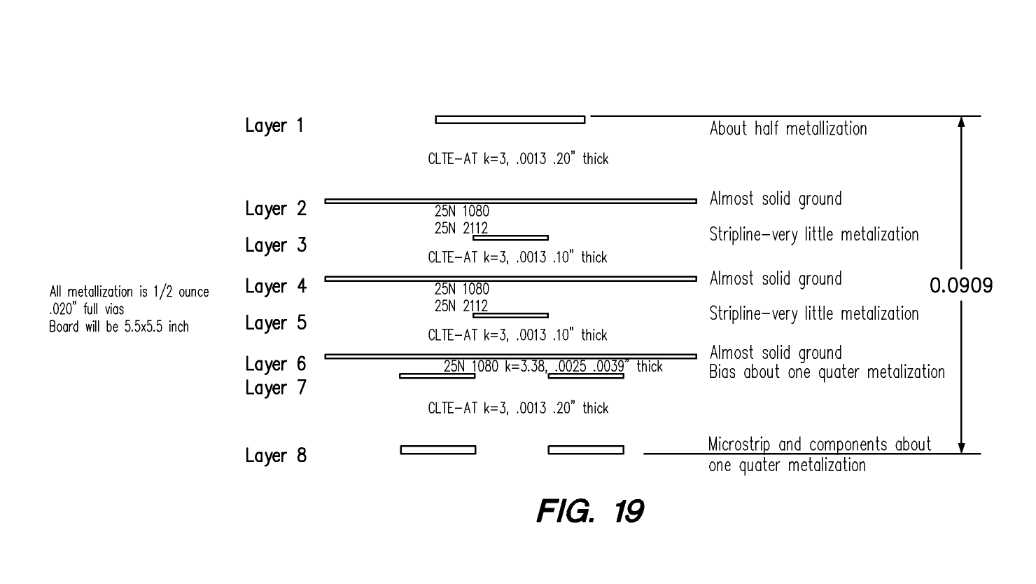

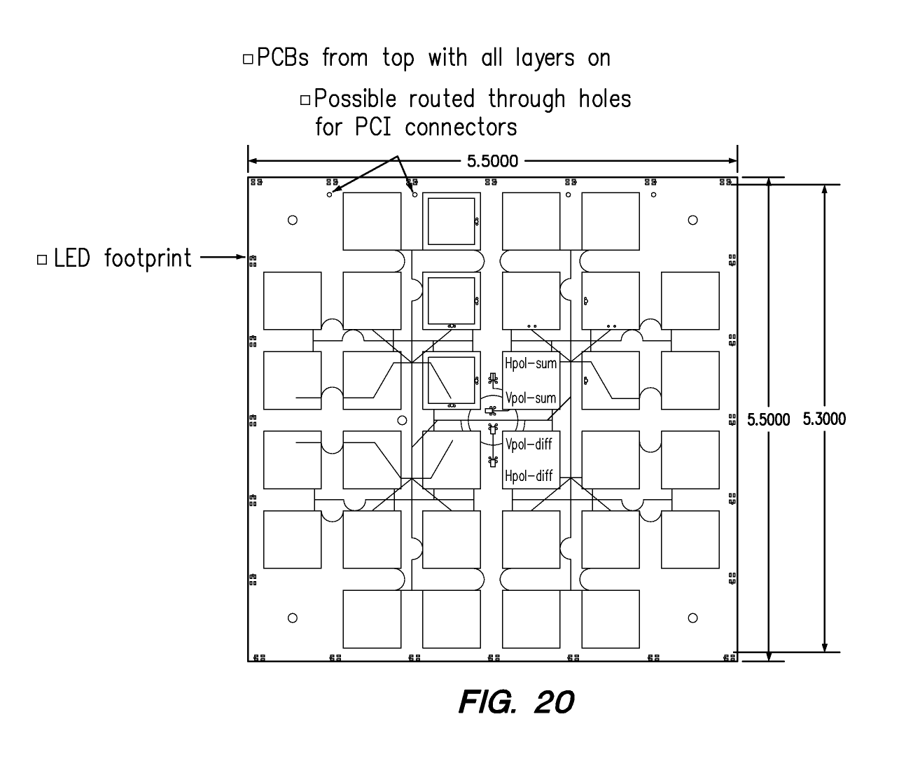

FIG. 19 illustrates antenna stack layers in accordance with an embodiment of the present invention. FIG. 20 illustrates an antenna printed circuit board patch array and feed networks in accordance with an embodiment of the present invention. An aspect of antenna performance is the material chosen that has low dielectric constant. Another factor is that by keeping the RF components on the same board's backside, losses due to cables, etc., are obviated. In this case, the RF signal output from the power amplifier travels less than 50 mils to get to the feed network. The antenna patches are spaced closer than typical phased array antennas. This causes more gain and at the same time gives design flexibility to adjust the taper and phase the patches to get exceptional planar rejection. Patches are preferably placed approximately a quarter wavelength apart or less. For example, for transmission in the 5 GHz frequency band, the spacing is preferably approximately 1.0 cm or less using the CLTE material for the board. All patches are also dual polarized and fed by the two feed networks running underneath on buried stripline layers.

The square patch size is preferably directly proportional to the wavelength. For example, the patch size is preferably approximately one wavelength tall and one wavelength wide, so for transmission in the 5 GHz frequency band, the patches are approximately 3.5 cm square. The 4 corner patches are preferably omitted since the feed network loss from the stripline running from the center to the corner is higher than the gain improvement by having those. This also helps in layout of components and features on the other side of the board due to a more open space becoming available. Overall 32 patches are used in the example implementation. A gain of about 17 dBi is obtained, and as can be seen, with 32 uncorrelated and independent patches, perfectly phase, one would expect about 15 dB gain over a single patch—or about 21 dBi (6 dB single patch gain adjusted for feed loss). So a price of about 4 dB in gain is paid for the improvements in planar rejection (through tapering) and small size benefits obtained.

For higher gain and directionality, a parasitic antenna board is employed with patches floating in air approximately 0.1 inch from the main antenna. This can be accomplished by attaching the parasitic antenna board to the main antenna board using spacers to provide an air gap between them. This tightly couples the electromagnetic waves in the forward direction. By using variable spacing and size for the patches on the parasitic board, a flatter frequency response of the antenna is obtained which contributes to good performance in the 5 GHz band due to the large bandwidth of operation (about 1 GHz). The feed network, patches and component layout are done iteratively so that the drilled via holes stay at least 50 mils from any RF signal carrying trace. This design rule helps to avoid signal distortions and loss. The race track in the middle of the antenna PCB shown in FIG. 20 provides the sum and difference antenna signals. This allows us to get a deep null in the difference signal at the boresight of the antenna where the sum port peaks in response. A differentiator of the design is the dual polarization of each patch. This allows for a very compact and yet highly efficient antenna. Also notable is the difference antenna which points a null to the desired signal direction. This allows a maximum separation between the interference and desired signal as long as the interferer is not directly along the same line as the two communicating radio units. Put together in this fashion, the entire antenna subsystem size is only 5.5 inches square. An equivalent performance set of antennas using single polarized, sum signal antennas alone, would take about 32 square feet in area. The benefit of using our unique antennas is very significant in a commercial deployment.

As shown in FIGS. 18-20, the antenna patch array includes a plurality of planar antenna patches arranged on a substrate. The substrate preferably measures approximately 5.5 inches by 5.5 inches or less. The plurality of planar antenna patches can each be approximately 3.5 centimeters by 3.5 centimeters with spacing between them being approximately one centimeter or less. In a preferred embodiment, there are a total of 32 patches as shown in FIG. 20. Each patch preferably has dual polarizations (vertical and horizontal). Additionally, the patches can be divided along a centerline into left and right groups. A feed network coupled to the left and right groups provides as output the in-phase sum signal and the out-of-phase difference signal. The dual polarizations, left and right groups, and the in sum difference signals effectively provide eight different antenna signals. Hence, the antenna device illustrated in FIGS. 18-21 functions as a multiple antenna MIMO device.

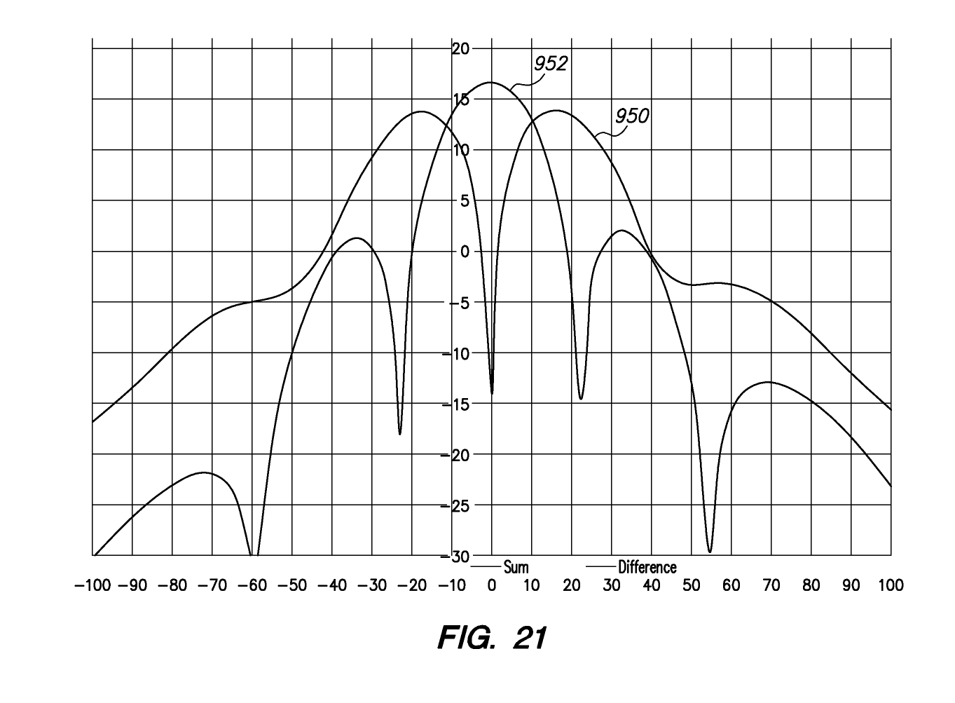

FIG. 21 illustrates calculated antenna interference separation performance in accordance with an embodiment of the present invention. In particular, FIG. 21 it shows simulated null and peak responses of the difference antenna port 950 and sum antenna port 952. By using such an antenna, the MIMO antenna matrix is invertible with very low processing loss in Signal to Noise Ratio almost in all directions.

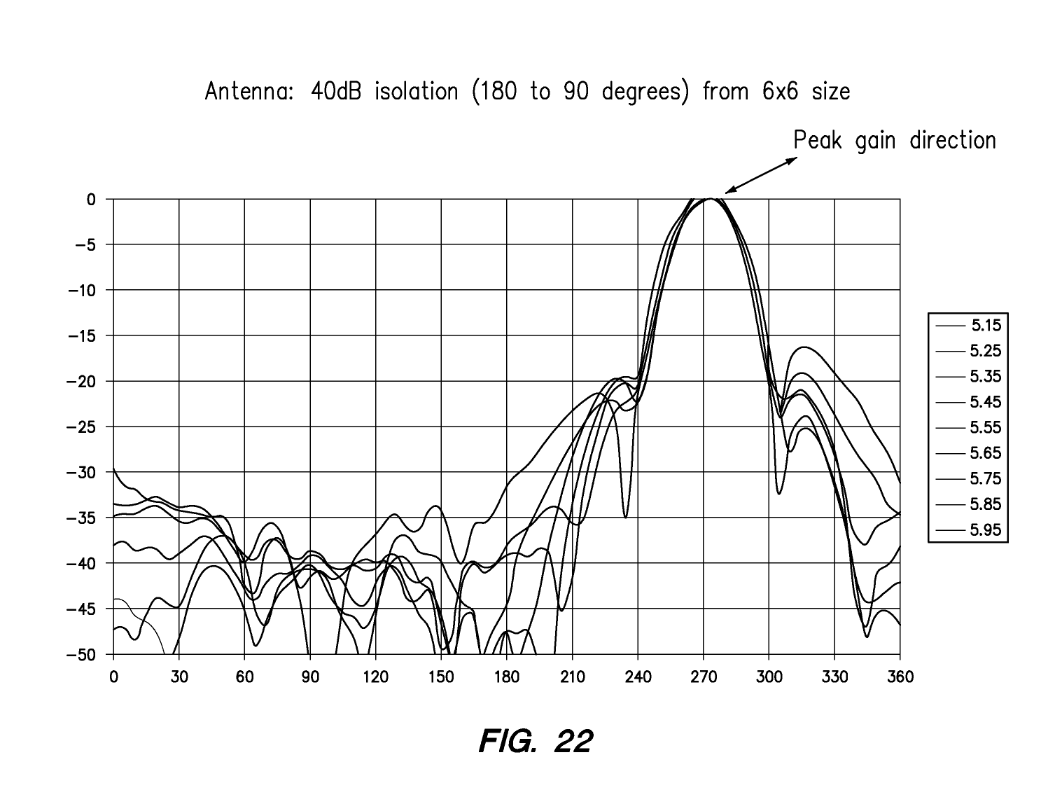

FIG. 22 illustrates actual measured antenna isolation and planar rejection performance in accordance with an embodiment of the present invention. A design objective of 40 dB from peak gain in the plane of the antenna is clearly achieved on average across the band of operation. One can also have two such designs optimized for the higher and lower portions of the band. This can provide even better performance than shown.

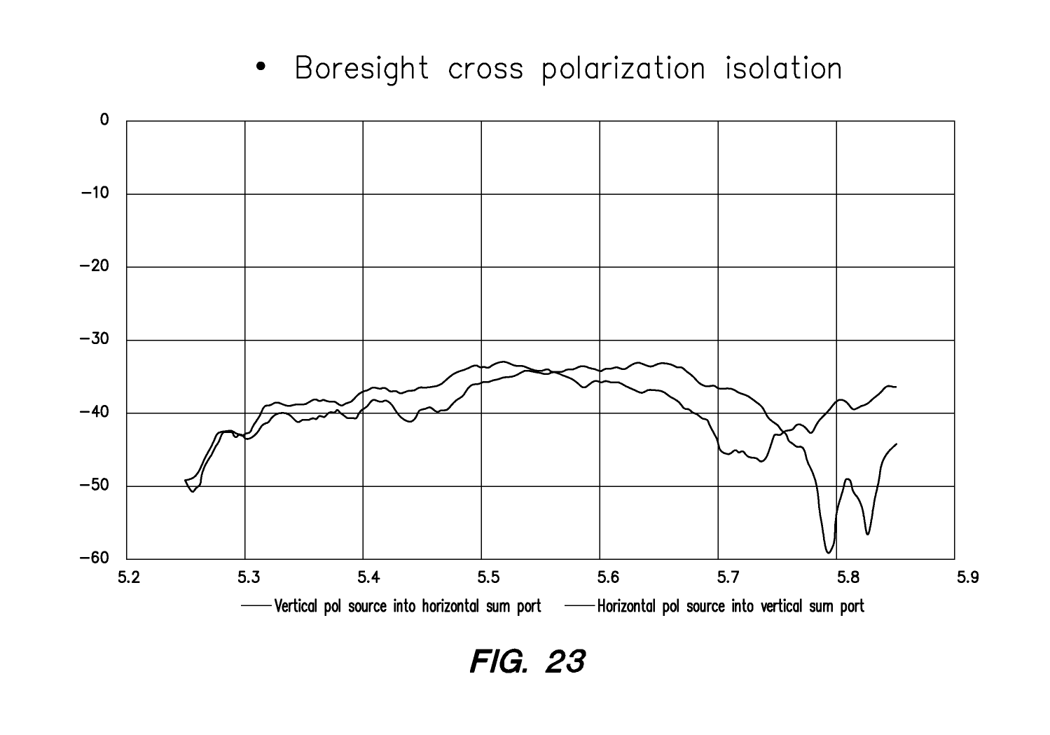

FIG. 23 illustrates measured antenna cross-polarization isolation performance in accordance with an embodiment of the present invention. The cross polarization rejection is close to 40 dB on average and allows for 256 QAM operation—the highest used in our example system without any further signal processing needed. This contributes to obtaining 1 Gbps speeds in less than 80 MHz occupied bandwidth.

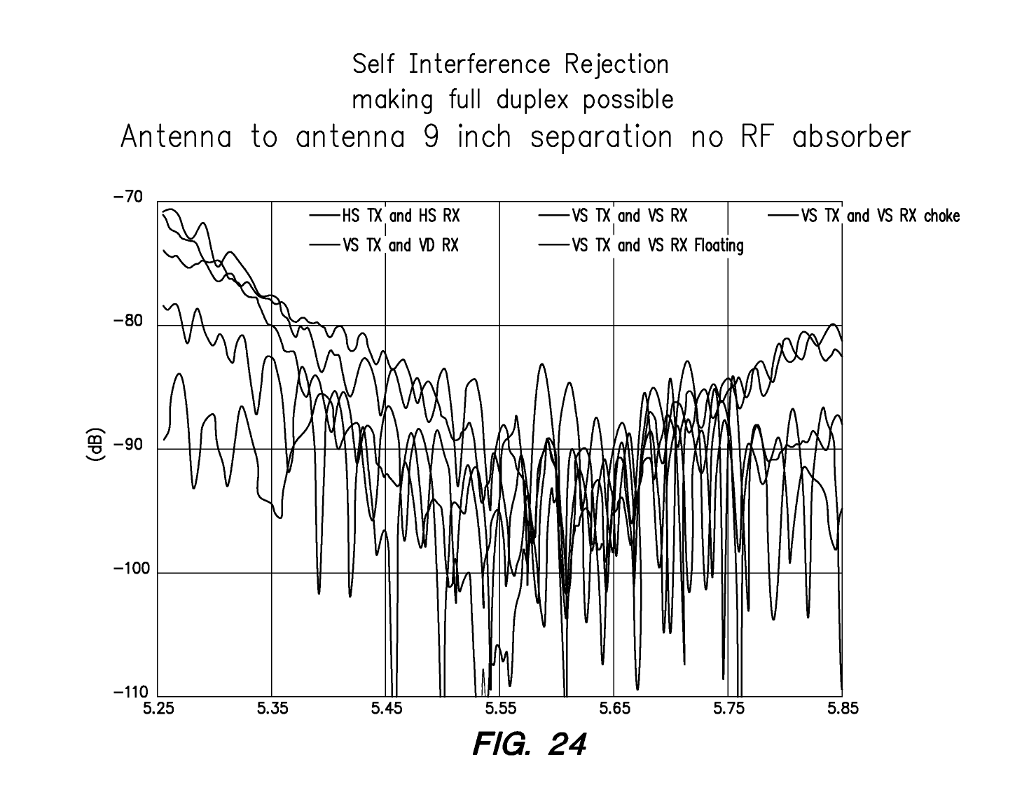

FIG. 24 illustrates measured antenna-to-antenna separation performance in accordance with an embodiment of the present invention in a full duplex configuration. With about 85 to 90 dB rejection of self-interference, our antenna design allows us to achieve 1 Gbps full duplex in a small 20 inch×6 inch form factor, without sacrificing any interference cancellation properties illustrated throughout this description.

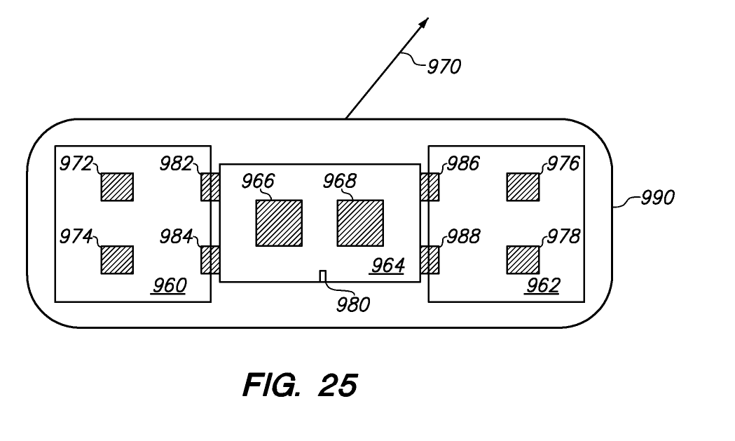

FIG. 25 illustrates a dual antenna array full duplex radio unit in accordance with an embodiment of the present invention. More particularly, the interference cancellation functionality described herein also allows full duplex operation in the same frequency channel at the same time. At either end of a communication link, two sets of the antennas 960, 962 can be provided in the exemplary system, connected to the same baseband digital processor as shown in FIG. 25. The digital processor 964 can include two FPGA's 966, 968 and uses the interference cancellation methods described herein. FIG. 25 shows the backside view of such a system with boresight antenna axis 970 extending out the other side. Also shown in FIG. 25 are transmit integrated circuits 972, 974, receive integrated circuits 976, 978, a common Ethernet connection 980, PCIE connectors 982, 984, 986, 988 and housing 990. By knowing the properties of the transmitted (interference to the receiver) signal completely, the digital processor 964 can cancel the interference caused to the receiver that is located close. Two of the 5.5 inch square antenna systems can be placed as close as 9 inches apart with the expectation a full 1 Gbps in both directions in the same channel.

The foregoing detailed description of the present invention is provided for the purposes of illustration and is not intended to be exhaustive or to limit the invention to the embodiments disclosed. Accordingly, the scope of the present invention is defined by the appended claims.

What is claimed is:

1. A system for wireless transmission of signals comprising:
a first radio unit configured to communicate desired communication signals with a second radio unit, the first radio unit having a plurality of antennas configured to simultaneously receive a plurality of desired communication signals within a frequency channel, wherein the first radio unit is configured to correlate signals received among its antennas to obtain one or more correlation coefficients, and using the correlation coefficients, the first radio unit is configured to multiply a received signal experiencing interference within the channel by an obtained correlation coefficient in order to remove interfering signals from the desired signals.

2. The system according to claim 1, wherein the plurality of antennas of the first radio unit comprise sum and difference antenna ports, each providing a corresponding in-phase sum and out-of-phase difference signal, the sum and difference signals being among the signals received by the antennas and used to obtain the one or more correlation coefficients.

3. The system according to claim 2, wherein the plurality of antennas of the first radio unit further comprise horizontal and vertical polarized antennas, each providing a corresponding horizontal and vertical polarized signal, the horizontal and vertical polarized signals being among the signals received by the antennas and used to obtain the one or more correlation coefficients.

4. The system according to claim 3, wherein the plurality of antennas of the first radio unit further comprise left and right side antennas, each providing a corresponding left and right signal, the left and right signals being among the signals received by the antennas and used to obtain the one or more correlation coefficients.

5. The system according to claim 4, wherein the first radio unit is configured to correlate signals received among its antennas to obtain a matrix of correlation coefficients and to multiply received signals experiencing interference by an inverse of the matrix of correlation coefficient in order to remove the interfering signals from the desired signals.

6. The system of claim 1 wherein the first radio unit and a third radio unit having multiple antennas are located in close proximity to each other and connected to the same baseband digital processor such that the first and third radio units operate in the same frequency channel in a full duplex manner and wherein the interfering signals are cancelled by the common digital processor.

7. The system of claim 2 wherein the antennas of the first radio unit are included in an antenna patch array that provides as output the in-phase sum signal and the out-of-phase difference signal, and wherein when the antenna patch array is pointed toward the second radio unit, the antenna patch array receives almost no desired communication signal on the difference antenna port thereby ensuring that an antenna matrix is invertible.

8. The system of claim 1, wherein the antennas of the first radio unit have at least a pair of orthogonal polarizations and wherein polarization of at least one interfering signal is identified and the desired signal is adaptively made orthogonal to it.

9. The system of claim 8, wherein the radio units of the pair agree through a control channel to use the polarization that is orthogonal to the interfering signal.

10. The system of claim 8, wherein the pair of orthogonal polarizations and sum and difference signals at the first radio unit are used simultaneously to enhance communication security by providing that a desired signal is decodable only by the first radio unit of the pair due to a nulling resulting from use of the orthogonal polarizations and the sum and difference signals.

11. The system of claim 1 wherein a null of at least one antenna of the first radio unit is steered in the direction of at least one interfering node and a null of another antenna of the first radio unit is steered in the direction of the desired signal so that the two antenna signals have a maximum separation.

12. The system of claim 1 wherein the desired communication signals are in accordance with a wireless communication standard.

13. The system of claim 12 wherein the correlation coefficients are obtained by analyzing received data packets that are scheduled to arrive sequentially and quasi periodically.

14. The system of claim 12, wherein the wireless communication standard is IEEE 802.11.

15. The system of claim 1 wherein the first radio unit is configured to communicate in accordance with OFDMA techniques and wherein a channel estimation and control channel is used to identify an optimal modulation technique usable for each of a plurality of sub carriers, the modulation technique being selected depending on fading and interference detected on each said sub carrier.

16. The system of claim 1, wherein the first radio unit is configured to communicate in accordance with OFDMA techniques and wherein a channel estimation and control channel is used to optimally allocate each of a plurality of sub carriers to a particular node in each sector.

17. The system of claim 1, wherein multiple antenna beamforming techniques are used in each of a plurality of sectors for interference cancellation.

18. The system of claim 1, wherein multiple antenna beamforming techniques are used in each of a plurality of sectors for increasing communication range.

19. The system of claim 18, wherein said increasing communication range is obtained through power level increase due to beamforming and traded off with interference cancellation efficiency.

20. The system of claim 1, wherein one or more interfering nodes in proximity of one or both of the first and second radio units simultaneously transmits one or more interfering signals in the same frequency channel used by the radio units.

21. A system for wireless transmission of signals comprising:
a first radio unit configured to communicate desired communication signals with a second radio unit, the first radio unit having a plurality of antennas configured to simultaneously receive a plurality of desired communication signals within a frequency channel and wherein the antennas of the first radio unit are included in an antenna patch array that provides as output an in-phase sum signal and the out-of-phase difference signal, and wherein the plurality of antennas of the first radio unit further comprise horizontal and vertical polarized antennas, each providing a corresponding horizontal and vertical polarized signal, and wherein the plurality of antennas of the first radio unit further comprise left and right side antennas, each providing a corresponding left and right signal.

22. The system according to claim 21, wherein the first radio unit is configured to correlate signals received among its antennas to obtain one or more correlation coefficients, and using the correlation coefficients, the first radio unit is configured to multiply a received signal experiencing interference within the channel by an obtained correlation coefficient in order to remove interfering signals from the desired signals.

23. The system according to claim 22, wherein the antenna patch array comprises a plurality of planar antenna patches arranged on a substrate that measures approximately 5.5 inches by 5.5 inches.

24. The system according to claim 23, wherein the plurality of planar antenna patches are each approximately 3.5 centimeters by 3.5 centimeters.

25. The system according to claim 24, wherein the plurality of planar antenna patches are spaced apart by approximately one centimeter or less.

26. The system according to claim 25, wherein the plurality of planar antenna patches consists of 32 patches.

27. The system according to claim 22, wherein the antenna patch array comprises a plurality of planar antenna patches, wherein each patch has dual polarizations and wherein the patches are arranged is left and right groups and wherein a feed network coupled to the left and right groups provides as output the in-phase sum signal and the out-of-phase difference signal.

28. The system according to claim 27, wherein the dual polarizations, left and right groups, and the in sum difference signals effectively provide eight different antenna signals.
